(19) United States
(12) Patent Application Publication
(10) Pub. No.: US 2017/0235757 A1
(43) Pub. Date: Aug. 17, 2017

(54) ELECTRONIC PROCESSING SYSTEM FOR ELECTRONIC DOCUMENT AND ELECTRONIC FILE

(71) Applicant: Kim Seng KEE, Kuala Lumpur (MY)

(72) Inventors: Kim Seng Kee, Kuala Lumpur (MY); Keong Hway Chhua, Kuala Lumpur (MY); Theng Soo Tan, Kuala Lumpur (MY); Kian Kok Cheung, Kuala Lumpur (MY)

(21) Appl. No.: 15/518,700

(22) PCT Filed: Oct. 13, 2015
(86) PCT No.: PCT/MY2015/050125

§ 371 Date: Apr. 12, 2017

(30) Foreign Application Priority Data
Oct. 13, 2014 (MY) PI2014703015

(51) Int. Cl. G06F 17/30; G06F 17/24

(52) U.S. Cl. CPC G06F 17/30182; G06F 17/243

(57) ABSTRACT

A system to emulate manual filing system by storing and processing document that operates on Relational Database Management System (RDBMS), comprising ; a Electronic Document (eDoc) (11) having at least one Electronic Document Identifier (eDoc-Identifier), Section, Rowtype and Column; a Program Module having at least one Electronic Form (eForm) to capture data entry based on set of instructions and data fields that pre-defined in at least one Electronic Dictionary (eDict); a Virtual Memory for storing the Electronic Document (eDoc) (11); and a Web-Read Module (4) for retrieving the Electronic Document (eDoc) (11) from the Virtual Memory based on at least one identifier of Electronic Document (eDoc) (11), in which the identifier is extracted based on the captured data entry of Electronic Form (eForm).

### FIELD OF INVENTION

The proposed invention relates to a system and method to emulate manual filing system by storing and processing document that operates on Relational Database Management System (RDBMS).

### BACKGROUND ART

An age of integration—in which data, images, audio and video are used together, often in the same document or process—has generated a real need for an efficient, seamless and intuitive means of storing and retrieving all this digital information. This usually means having to manage complex relationships between stored entities. Traditional methods involve breaking up and placing parts of the data into various tables so that a relational database management system (RDBMS) can handle them: this highly complex task involves designing and managing relationships between data items stored in the various tables.

Software development for enterprise is complex and time consuming as it may require hundreds of man years. The main contributor to complexity is the tens of thousands of tables necessary in an enterprise system. The design of the database together with the primary and foreign keys complicates SDLC. Also tables require extra programs to link and split documents.

The legacy system that uses RDBMS as its database cannot store documents and folios, the documents and folios must be split into tables with different primary keys and foreign keys to be able to store onto RDBMS. The thousands of table designs must include all input tables, intermediate tables and output tables is a very complicated undertaking.

The thousands of tables complicate systems development life cycle (SDLC) & complicates data managements. Therefore, to provide a one view of customer folio, general ledger folio, stock folio, etc. is a difficult effort as the data must be transformed between each process (web, transmission, storage, processing (batch, on-line, BPM), data-warehousing, data-mining, output.

In Legacy system, it is difficult to integrate data & system because it is usually developed by different group as Legacy systems involve thousands of tables. The Documents, Flows, Business Rules & Codes are often lost in the process, therefore difficult for business personnel to talk to the computer people.

Because of the complexity, software changes are slow, complex & expensive, the dateline are difficult to meet. What is really needed is an efficient system which stores structured, semi-structured and unstructured data (and the schema which describes the data), and manages the relationships between data items.

Therefore an invention is proposed a system to emulate manual filing system by storing and processing electronic document that operates on Relational Database Management System (RDBMS).

### SUMMARY OF INVENTION

The present invention provides a system to emulate manual filing system by storing and processing document that operates on Relational Database Management System (RDBMS), comprising; a Electronic Document (eDoc) having at least one Electronic Document Identifier (eDoc-Identifier), Section, Rowtype and Column; a Program Module having at least one Electronic Form (eForm) to capture data entry based on set of instructions and data fields that pre-defined in at least one Electronic Dictionary (eDict); a Virtual Memory for storing the Electronic Document (eDoc); and a Web-Read Module for retrieving the Electronic Document (eDoc) from the Virtual Memory based on at least one identifier of Electronic Document (eDoc), in which the identifier is extracted based on the captured data entry of Electronic Form (eForm).

Preferably, the Web-Read Module for retrieving the Electronic Document (eDoc), further comprising; a Paging Module having the Electronic Document (eDoc) append into at least one Electronic File (eFile) in the RDBMS according to a predefined Page limit; a Index Module having at least one Index for the Electronic File (eFile) based-on document identifier, date, end sequence number, document status, document offset and document length; and a Read Module to obtain the Index and at least one Data Relative Page of the Electronic File (eFile) from the Index Module based on the identifier, in which the Electronic Document (eDoc) retrieved from the Paging Module based on the retrieved Index and Data Relative Page to be stored in the Virtual Memory and update the Index Module.

Preferably, the identifier of Electronic Document (eDoc) comprising the Electronic Document Identifier (eDoc-Identifier), Section, Rowtype and Column.

Preferably, the identifier of Electronic Document (eDoc) comprising document identifier, date, end sequence number, document status, document offset and document length.

A further aspect of present invention provides a system to emulate manual filing system by storing and processing document that operates on Relational Database Management System (RDBMS), comprising; a Enquiry Module for retrieving a pluralities of Electronic Document (eDoc) information based on at least one Information for the Electronic Document Identifier (eDoc-Identifier), Section, Rowtype and Column of Electronic Document (eDoc), in which the retrieved Electronic Document (eDoc) information having at least one file history display into at least one list form.

Preferably, the list form having at least one predefined information for each document.

Preferably, the Enquiry Module, further comprising a Editing Module to load the retrieved Electronic Document (eDoc) for updating the retrieved Electronic Document (eDoc) and store at least one Updated Data to the Virtual Memory.

Preferably, the Enquiry Module, further comprising a Viewing Module to load the retrieved Electronic Document (eDoc) for viewing the retrieved Electronic Document (eDoc).

Preferably, the Enquiry Module further includes a Searching Module, wherein the Searching Module retrieves the Electronic Document (eDoc) using the Web-Read Module based-on at least one Index, in which the index is retrieved from the identifier of Electronic Document (eDoc) comprising document identifier, date, end sequence number, document status, document offset and document length.

Preferably, the Web-Read Module further includes a Uploading Module to upload the Electronic Document (eDoc) based the identifier of Electronic Document (eDoc), in which the Uploading Module establish connection to at least one server having RDBMS and update the RDBMS with the uploaded Electronic Document (eDoc).

The present invention provides a method to emulate manual filing system by storing and processing document that operates on Relational Database Management System (RDBMS), comprising steps of; retrieving predefined Program (eProgram) using a Program Module from database; loading the predefined Program it into at least one Electronic Form (eForm) to enable data entry of at least one user input (101); verifying if eDoc available to load the eDoc data in the eForm based on the user input (102); extracting the data entry of user input from the eForm (104); verifying the extracted data entry using a Program Module based on a set of rules that assist user on entering valid data and a verification tools that assist manipulating eForm and eDoc (104); saving the verified data into a eDoc (105); verifying if the saved eDoc has at least one Flow Control program defined by Electronic Business Processing Module (eBPM); submitting the saved eDoc to eBFS to define at least one Flow Control (108); transferring the defined eDoc to a Transaction Processing Module to regulate the eDoc to be in Sarbanes-Oxley (SOX) compliance; and storing the eDoc in to a database.

Preferably, the verifying if eDoc available to load the eDoc data in the eForm based on the user input (102), further comprising steps of; retrieving the eDoc using at least one Web-Read Module based on the user input; and loading the data from the retrieved eDoc into the loaded eForm.

Preferably, the verifying if the saved eDoc has at least one Flow Control program defined by Electronic Business Processing Module (eBPM), further comprising steps of; logging-in using predefined details in at least one Login Module (1101); retrieving the log in details (1102); validating the login detail with the login details defined in the database (1103); retrieving a security matrix control setting having user access privileges (read, write, update and delete) on the Document Identifier of the eDoc by using Read Module (1104); and defining at least one task to the eDoc using at least one predefined program (1105).

Preferably, the defining at least one task using at least one predefined program (1105), further comprising steps of; Retrieving at least one predefined task by using Read Module (1202); Selecting the predefined task based on a predefined task list by using Web-Read Module; Verifying if there is a Document Identifier for the eDoc from previous task; generating a new Document Identifier(1203); loading the predefined task from Web Processing program system (1204); retrieve the eDoc from Web Processing program (1205); and saving the predefined task to the eDoc (1206).

Preferably, the saving the predefined task to the eDoc(1206), further comprising steps of; retrieve the master process flow information by using Read Module (1301); saving the predefined task by using a Transaction Processing Module (1302); validate the predefined current task by using Web-Read Module (1303); create a new operational workflow ID for this process by using Web-Read Module, If System identified current task is new task in the workflow (1304); updating current task in operational workflow metering status by using Updating Module, if System identified current task is not new task in the workflow(1305); saving the current task to database by using Transaction Processing Module (1306); verifying if the current task is completed (1307); and updating the completed tasks in operational workflow to master Ledger by using Transaction Processing Module (1308).

Preferably, the updating current task in operational workflow metering status by using Updating Module, if System identified current task is not new task in the workflow (1305), further comprising steps of; logging-in using predefined details in at least one Login Module (1401); retrieving the log in details (1402); validating the login detail with the login details defined in the database (1403); retrieving a security matrix control setting having user access privileges (read, write, update and delete) on the Document Identifier of the eDoc by using Read Module (1404); performing at least one metering enquiry to the eDoc using at least one predefined enquiry program (1405); retrieving at least one parameters to enquiry the targeted result based on at least one user input (1501); parsing the input by using Web-Read Module then send to enquiry program (1502); generating at least one task metering result based on the enquiry parameters using Read Module (1503); Validating if the user selects any task management for assign or unassign task (1504); loading at least one predefined Manage Job program, if user selects task management to assign or unassign task (1505); Retrieving at least one user role based on the task (1601); retrieving the selected task information by using Web-Read Module (1602); Verifying, if the user would like to update task status (1603); Performing a task status update when user create, execute, update and delete the task (1604); Verifying if user would like to assign or unassign task, if user does not update the task status (1605); Verifying the user role based on predefined user role ranking (1606); updating at least one task setting and assign the task to at least one user by using Updating Module, then save the task setting to database by using Transaction Processing Module (1607); Verifying if user would like to edit task, if user does not assign or unassign task (1608); and updating the task edit details such time, duration and User ID by using Updating Module, then save the task to database by using Transaction Processing Module (1609).

Preferably, the saving the current task to database by using Transaction Processing Module (1306), further comprising steps of; logging-in using predefined details in at least one Login Module (1701); retrieving the log in details (1702); validating the login detail with the login details defined in the database (1703); retrieving a security matrix control setting having user access privileges (read, write, update and delete) on the Document Identifier of the eDoc by using Read Module (1704); performing at least one control setting to the eDoc using at least one predefined control program (1705); retrieving at least one user role based on the setting (1801); verifying if the current user role is Administrator (1802); performing user sign up and security matrix setting; verifying if user selected User Control (1803); loading Sign Up program, If user selected User Control (1804); verifying if user selected Document Identifier Access Privileges (1805); retrieving selected user security matrix setting by using Read Module, if user selected set user Document Identifier Access Privileges (1806); setting at least one access privileges for Document Identifier Read, Write, View and Delete by using Web-Read Module; and saving the access privileges to database by using Transaction Processing Module (1807).

Preferably, the loading Sign Up program, If user selected User Control (1804), further comprising steps of; Retrieving at least one User ID(1901); verifying the User ID in the eDoc by using Web-Read Module (1902); verifying if the user would like to perform sign up by determining User ID in submitted account eDoc is empty; verifying if the user would like to perform update user account process, if submitted account eDoc is not empty (1903); submitting the User ID in the submitted account eDoc to perform User ID existence checking by using Transaction Processing Module, If User ID in submitted account eDoc is empty (1904); vreating at least one new user account for the User ID, If the User ID does not exist (1905); generating the User ID for the new user account and saved in submitted eDoc (1906); and updating the submitted account eDoc in the user account Ledger by using Transaction Processing Module, If User ID in submitted account eDoc is not empty (1907).

A further aspect of present invention provides a method having Communication Processing Module, further comprising steps of; receiving eDoc to start the process (501); identifying the process from row identifier that stated in the eDoc using Web-Read Module (502); validating the process from row identifier (503); triggering error message, If not valid request (504); and directing the eDoc to the requested process, If valid process (505).

A further aspect of present invention provides a method having Online Processing Module, comprising steps of; receive ledger identifier, document identifier, date and time to start the process (601); delaying the process till the predefined date and time (602); summing the data of predefined field(s) from eDocs from the predefined document identifier in Transaction eLedger (LT10) and Master eLedger(LM) based on the last processed date and time; retrieving the eDoc using the Read Module and each field(s) from eDocs are retrieved using the Web-Read Module (603); compares the summed value (604); validating if the summed value(s) from LT10 and LM is/are tally (605); locating the missing eDoc in LM from LT10 and store and update the missing eDoc into LM through Transaction Processing Module; and updating the process completion date and time to the process log , if summed value(s) tally, (607).

A further aspect of present invention provides a method having Batch Processing Module, comprising steps of; obtain a batch of eDocs (701); extract pre-summed balance(s) from the batch header for later comparison (702); summing the data of predefined field(s) from eDocs. Each field(s) from eDocs are retrieved using the Web-Read Module (703); comparing the summed value(s) with pre-summed balance(s) (704); validating if the summed value(s) and pre-summed balance(s) is/are tally (705); storing the entire batch of eDocs to Transaction Ledger (LT10) and Master Ledger (LM) using Transaction Processing Module, if summed value(s) and pre-summed balance(s) is/are tally (706); and prompting output error, if summed value(s) and pre-summed balance(s) is/are not tally (707).

A further aspect of present invention provides a method having Storage Procecing Module, comprising steps of; obtaining at least one Index and at least one Data Relative Page of a Electronic File (eFile) having document identifier, date, end sequence number, document status, document offset and document length from a Index Module based on the identifier; retrieving the Electronic Document (eDoc) from a Paging Module based on the Index and Data Relative Page in the RDBMS; and storing the Electronic Document (eDoc) in the Virtual Memory; and updating the Index Module.

A further aspect of present invention provides a method having Enquiry Processing Module, comprising steps of; retrieving a pluralities of Electronic Document (eDoc) information based on at least one Information for the Electronic Document Identifier (eDoc-Identifier), Section, Rowtype and Column of Electronic Document (eDoc) using a Enquiry Module; and displaying the retrieved Electronic Document (eDoc) information having at least one file history into at least one list form.

A further aspect of present invention provides a method having Parellel Processing Module, comprising steps of; receiving instruction either to create 10, 100 or 1000 databases and ledger identifier to be processed from a program (2201); creating databases based on the input instruction (2202); distributing eDocs from the defined ledger to databases created based last 2 or last 3 digit(s) of account number is used to determine which database the eDoc to be distributed using Paging and Index Module (2203); initiate parallel processing once all eDocs have been distributed into the designated databases (2204); and updating the processed result to the predefined Control eLedger through the Mapping Module (2205).

A further aspect of present invention provides a method having Mapping Processing Module, comprising steps of; receiving source eDoc from a program (2301); parsing source eDoc for later operation using Extraction Module (2302); identifying and loading destination eDoc from the source eDoc (for later updating) using Read Module (2303); loading a predetermined mapping instructions (2304); validating if there are more mapping instruction (2305); validating if the data of the predetermined source column fulfill the predetermined requirement(s) from the mapping instruction, if there are more mapping instruction (2306); performing computation on the data of the predetermined source column from the mapping instruction, if the data of the predetermined source column fulfill the predetermined requirement(s) from the mapping instruction, then (2307); and storing the updated destination eDoc back into database using Paging and Index Modules (2309).

A further aspect of present invention provides a method having Transaction Processing Module, comprising steps of; receiving eDoc from a program (2401); store received eDoc into Transaction eFile using Paging and Indexing Module (2402); update received eDoc to Transaction eLedger using Paging and Indexing Module (2403); verifying if Transaction eLedger updated successfully (2404); storing the received eDoc into Master eFile using Paging and Indexing Module, if received eDoc updated successfully (2405); updating received eDoc to Master eLedger using Mapping Module (2406); verifying if Master eLedger updated successfully (2407); and returning the update status, if Master eLedger updated successfully (2408).

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF PREFERRED EMBODIMENT

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

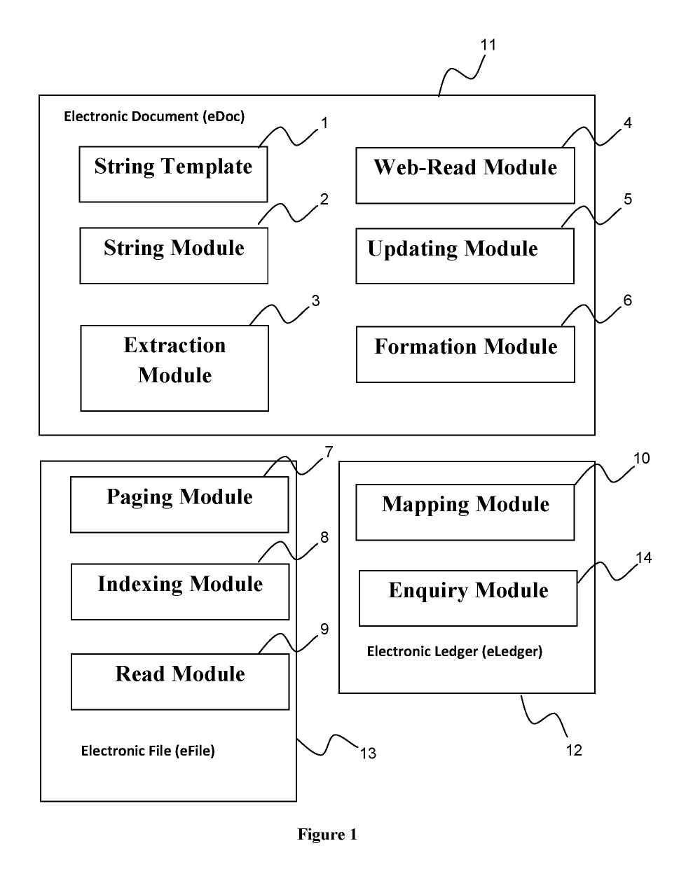

FIG. 1 illustrates overall architecture of the Electronic Document (eDoc) and Electronic File (eFile).

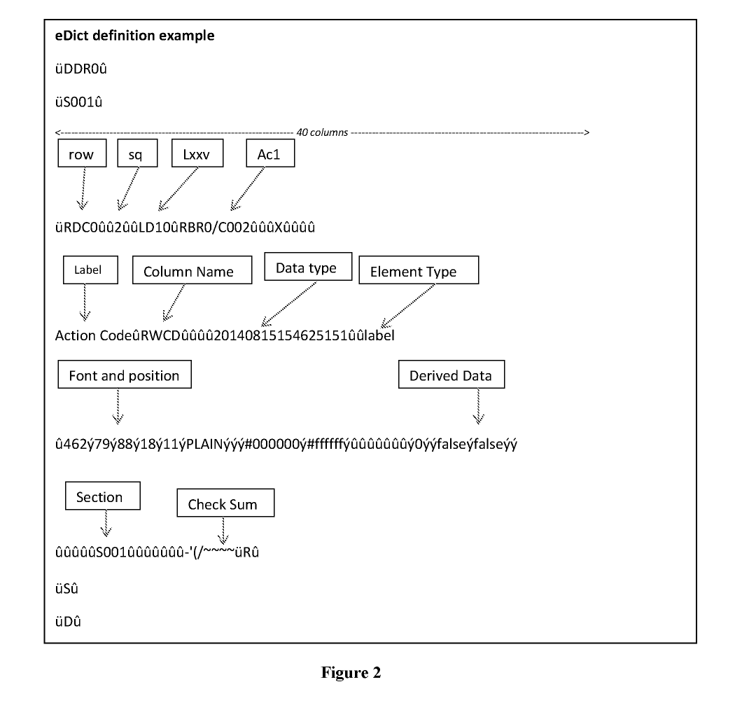

FIG. 2 illustrates an example of Electronic Dictionary (eDict) or metadata is used to describe the attribute/behavior in a string.

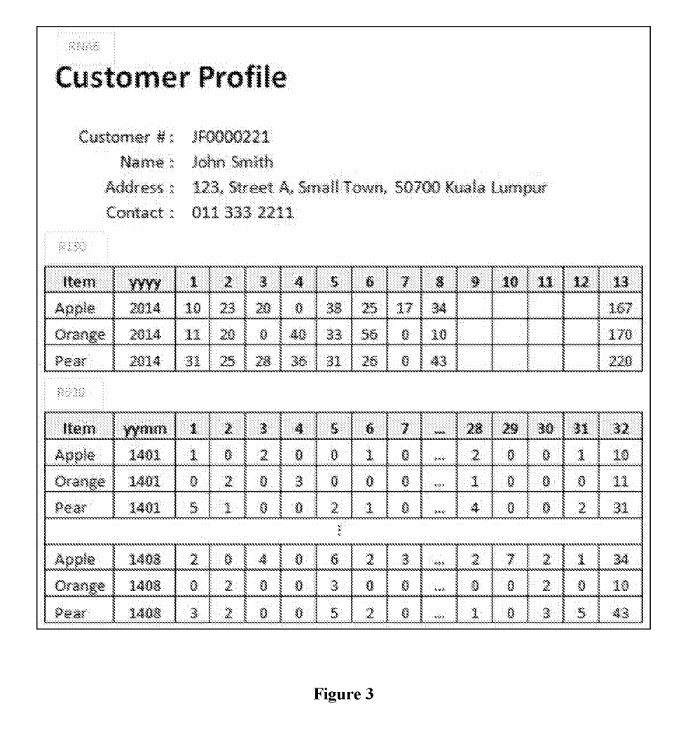

FIG. 3 illustrates an example eLedger containing details of a customer profile and item details.

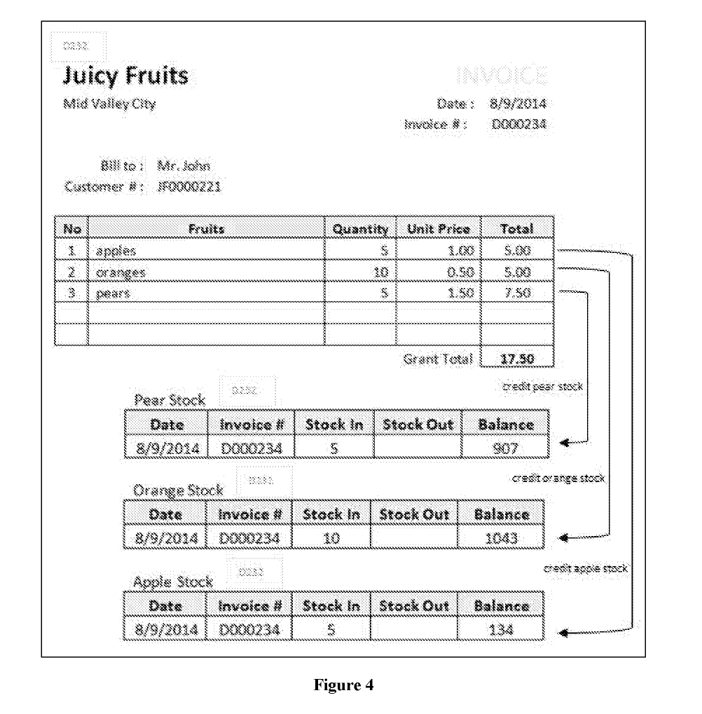

FIG. 4 illustrates an example creation of subDoc based on the example as in FIG. 3.

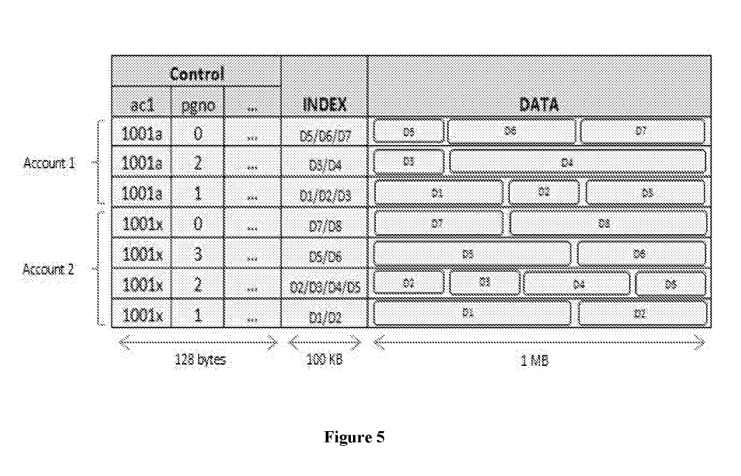

FIG. 5 illustrates an example of how eFiles store in a RDBMS Table.

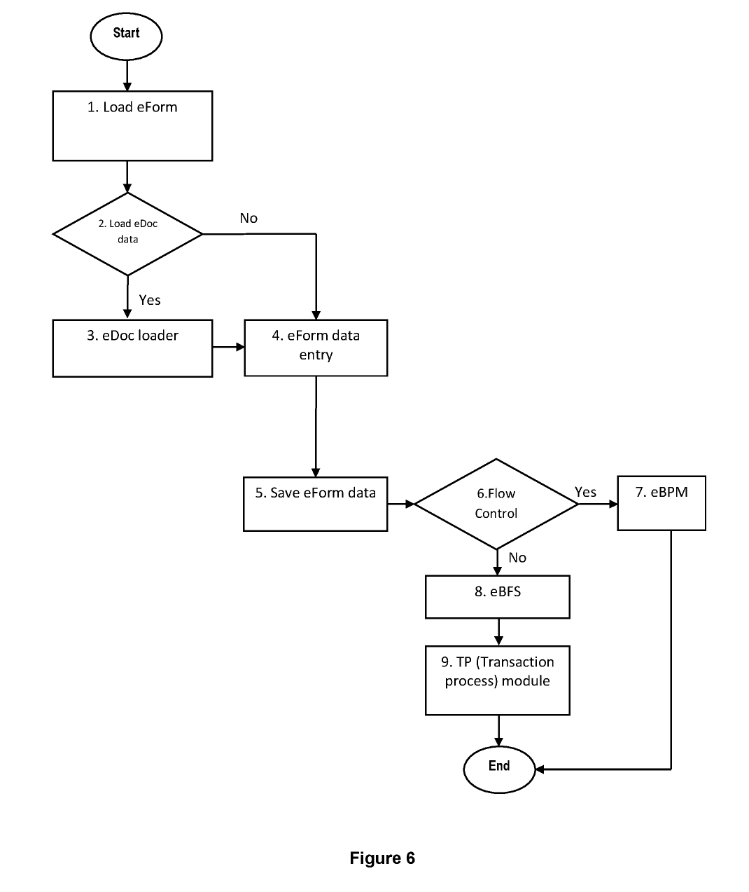

FIG. 6 illustrates a overall flow chart of Web processing module to generate and load Electronic Form (eForm) based on Electronic Document (eDoc).

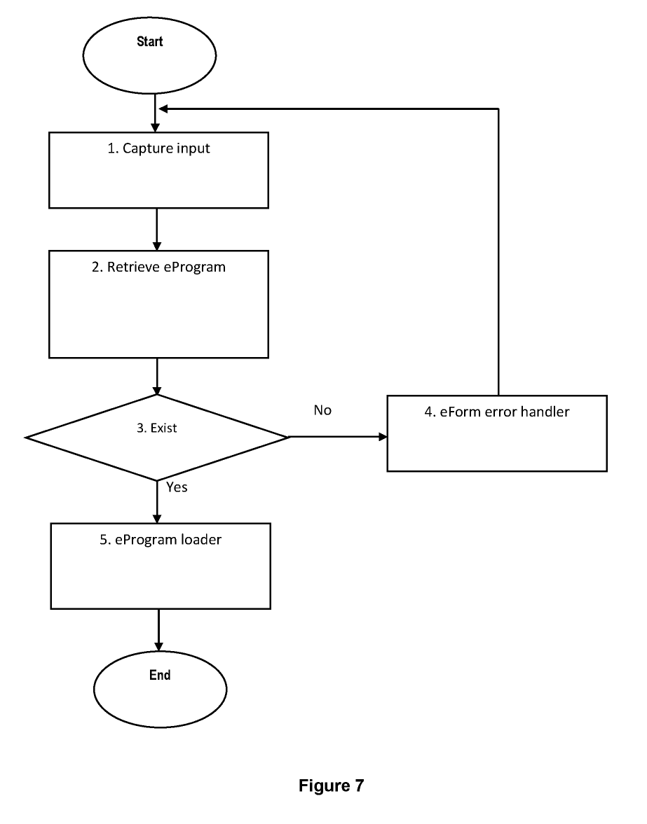

FIG. 7 illustrates a flow chart of Web processing sub-module to retrieve predefined Program (eProgram) in a Program Module from database and load it into Electronic Form (eForm).

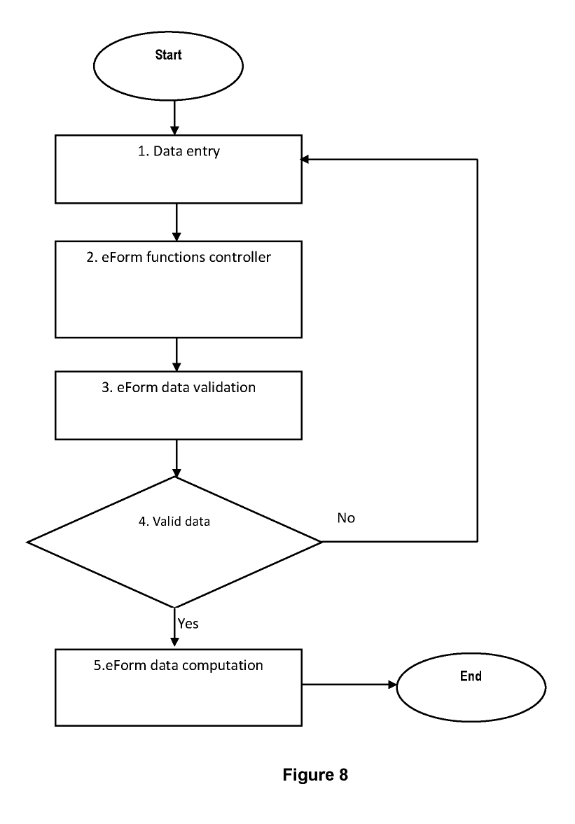

FIG. 8 illustrates a flow chart of Web processing sub-module to perform computation on the Electronic Form (eForm) based on retrieve data entry.

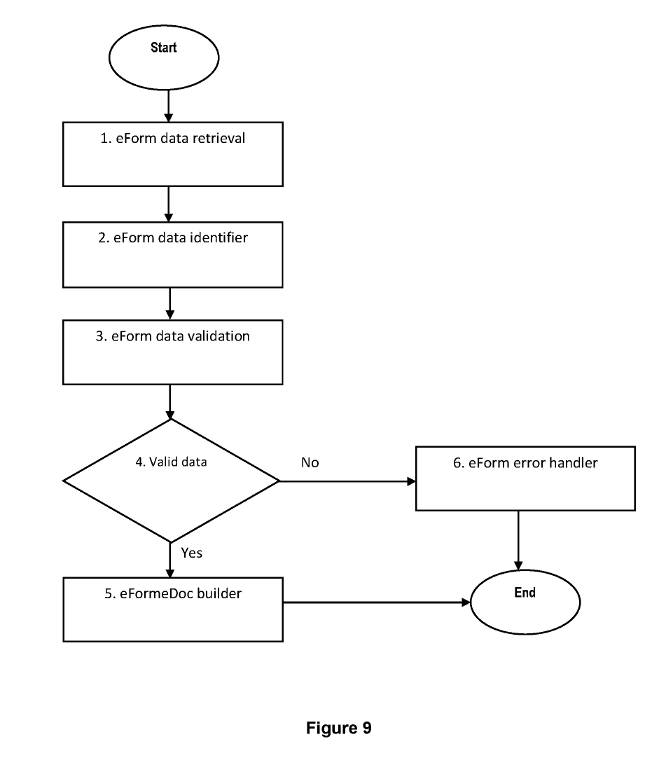

FIG. 9 illustrates a flow chart of Web processing sub-module to build a Electronic Form (eForm) Electronic Document (eDoc) based on predefined validation.

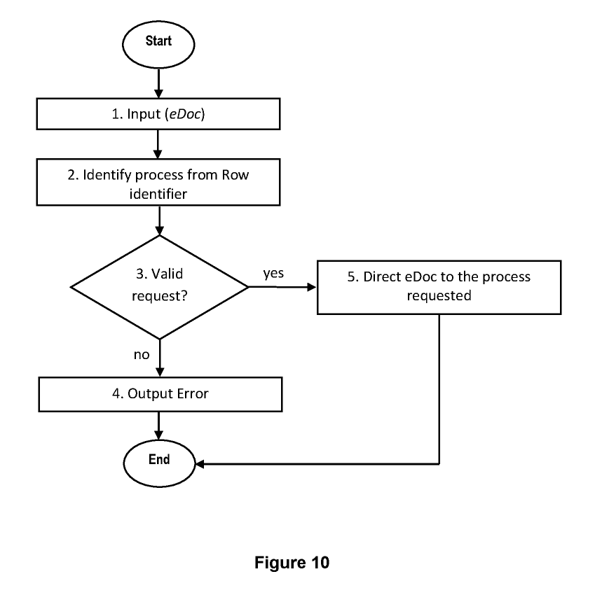

FIG. 10 illustrates a flow chart of Communication Processing module to identify and direct the eDoc to the requested process.

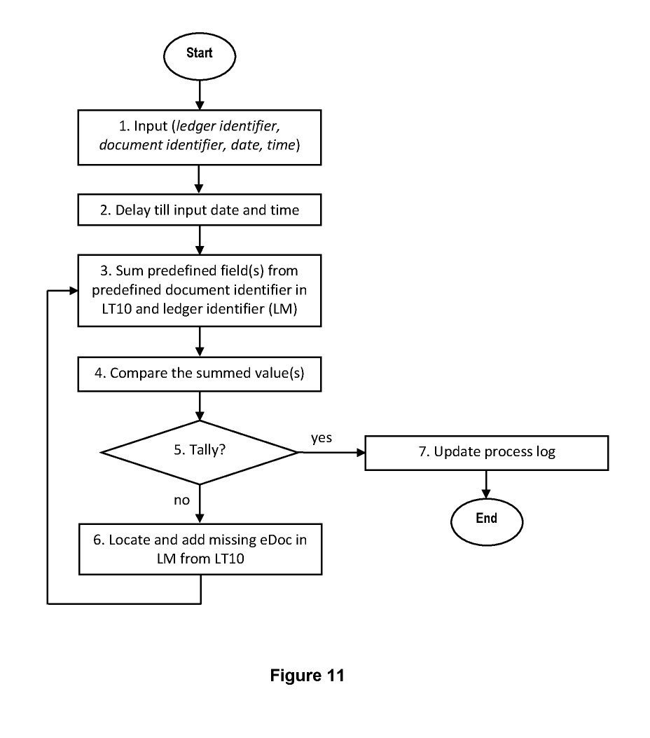

FIG. 11 illustrates a flow chart of a Online Processing Module to validate a total sum of the transactions of Transaction eLedger and Master eLedger.

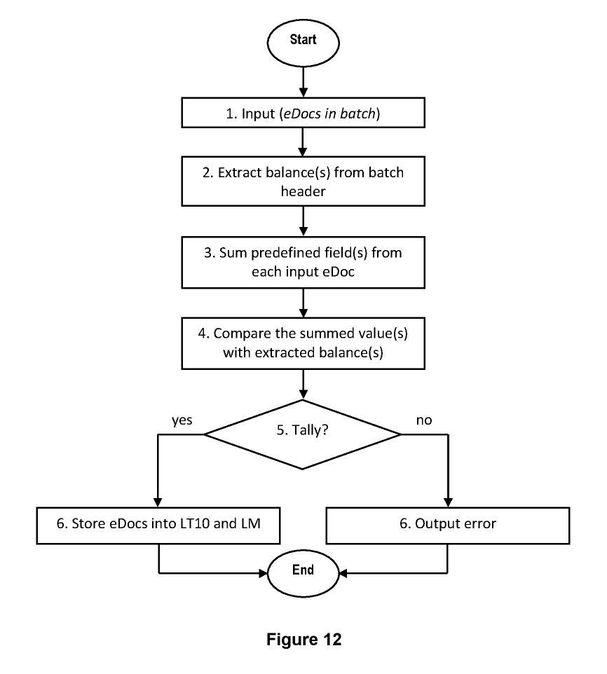

FIG. 12 illustrates a flow chart of a Batch Processing Module to compare the sum balance of each transaction from a batch of eDocs and the total sum with the pre-summed value from the batch header of eDocs.

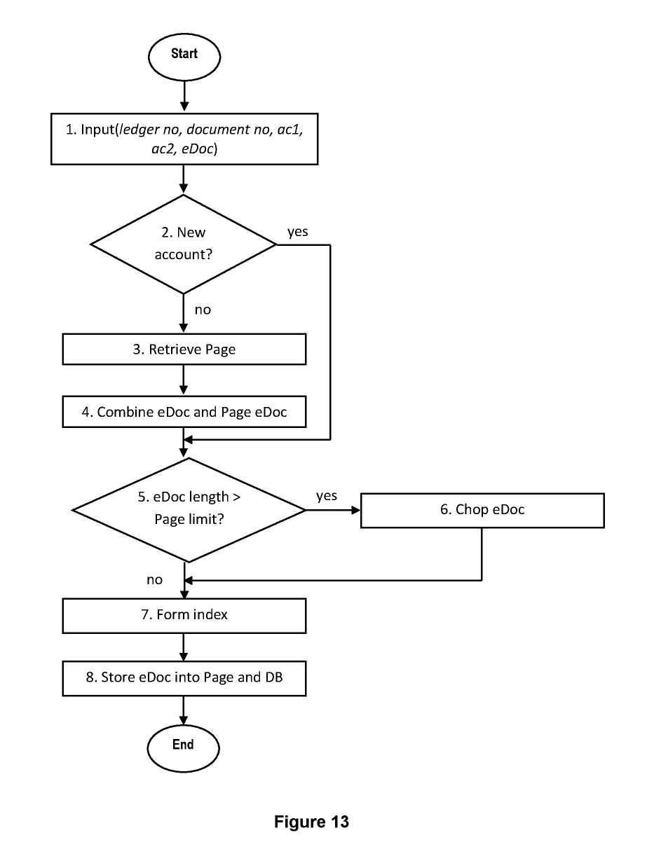

FIG. 13 illustrates a flow chart of a Storage Processing Module for storing transaction (eDoc) into database using the Paging Module.

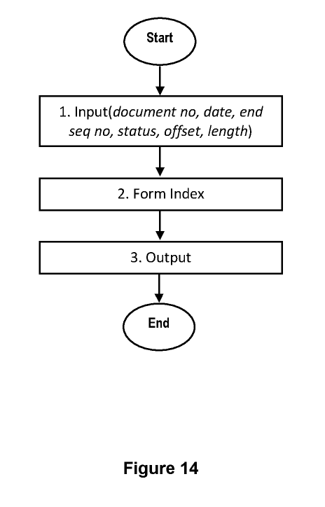

FIG. 14 illustrates a flow chart of a Storage Processing Module for storing transaction (eDoc) into database using the Index Module.

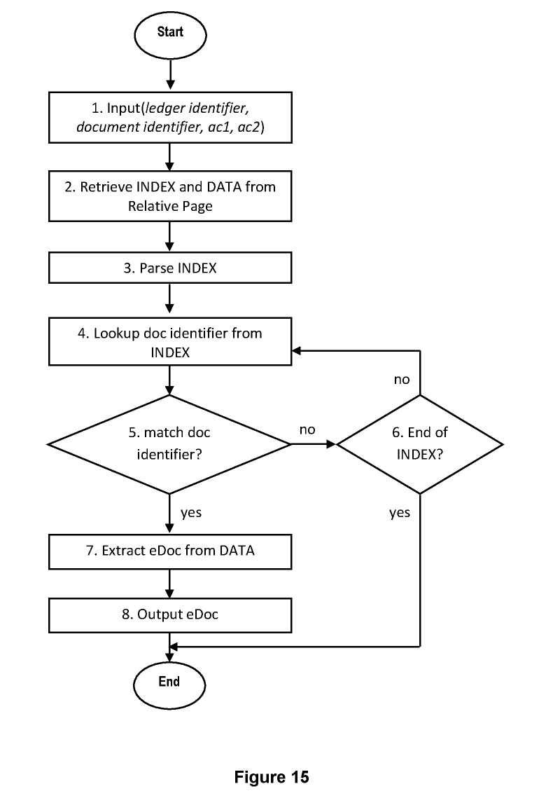

FIG. 15 illustrates a flow chart of a Storage Processing Module for storing transaction (eDoc) into database using the Reading Module.

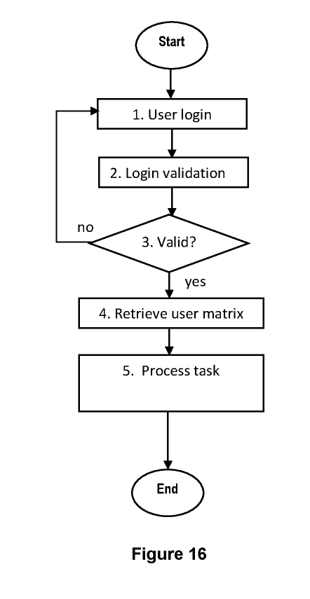

FIG. 16 illustrates a flow chart of a Electronic Business Processing Module (eBPM) to identify and assign at least one task sequences and storing into Electronic Filing (eFiling) system

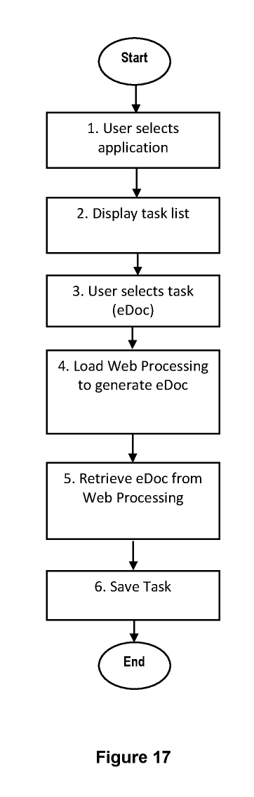

FIG. 17 illustrates a flow chart of a Electronic Business Processing sub-Module (eBPM) to select and save at least one task sequences.

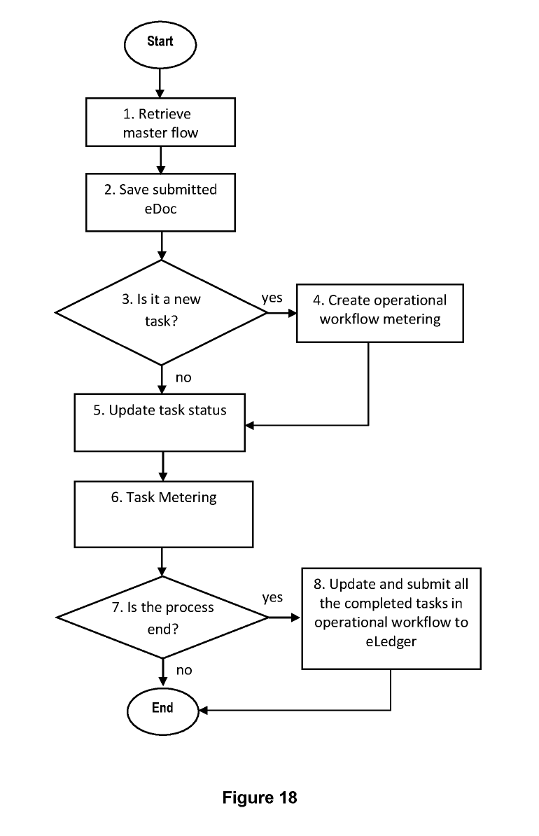

FIG. 18 illustrates a flow chart of a Electronic Business Processing sub-Module (eBPM) to create and update at least one task sequences.

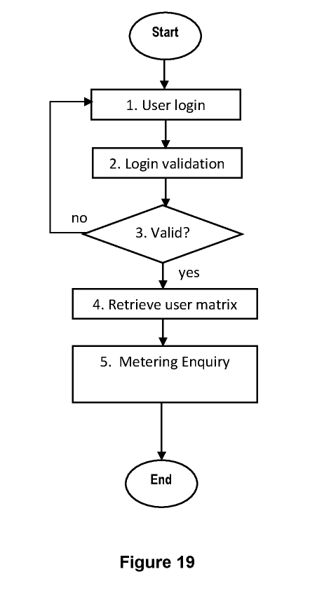

FIG. 19 illustrates a flow chart of a Electronic Business Processing sub-Module (eBPM) to performs metering enquiry based on user validation.

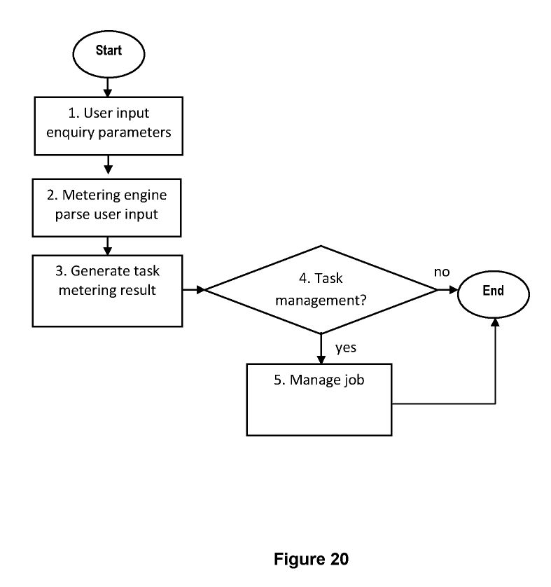

FIG. 20 illustrates a flow chart of a Electronic Business Processing sub-Module (eBPM) to display metering result and task management based on user login detail.

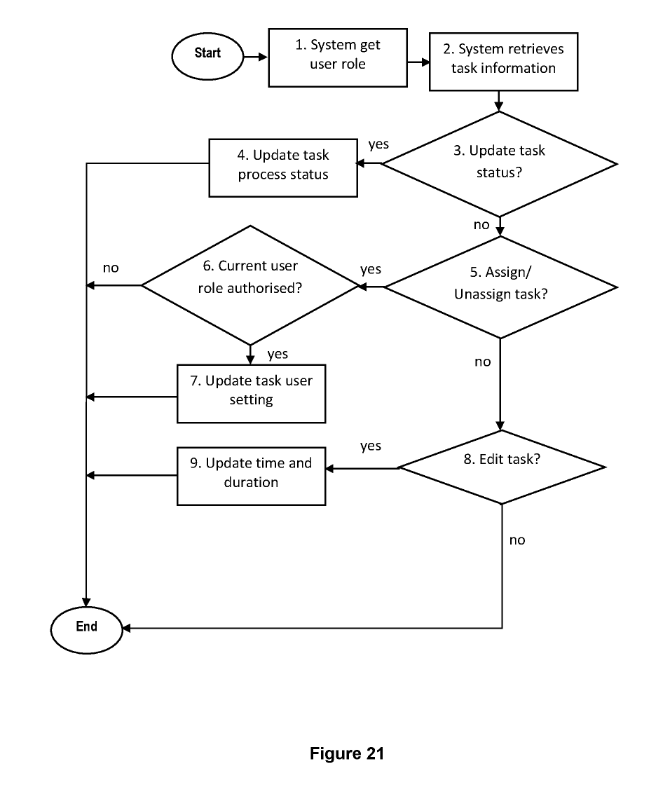

FIG. 21 illustrates a flow chart of a Electronic Business Processing sub-Module (eBPM) to update status and assign task based on retrieved user role.

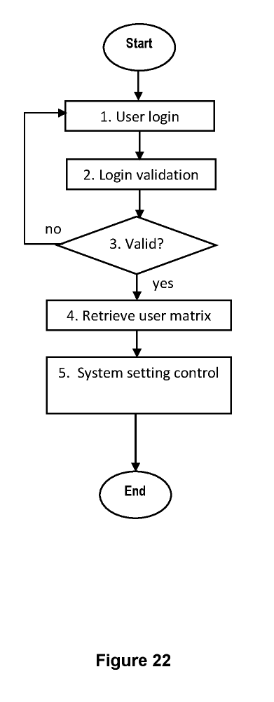

FIG. 22 illustrates a flow chart of a Electronic Business Processing sub-Module (eBPM) to performs system setting control based on user login detail.

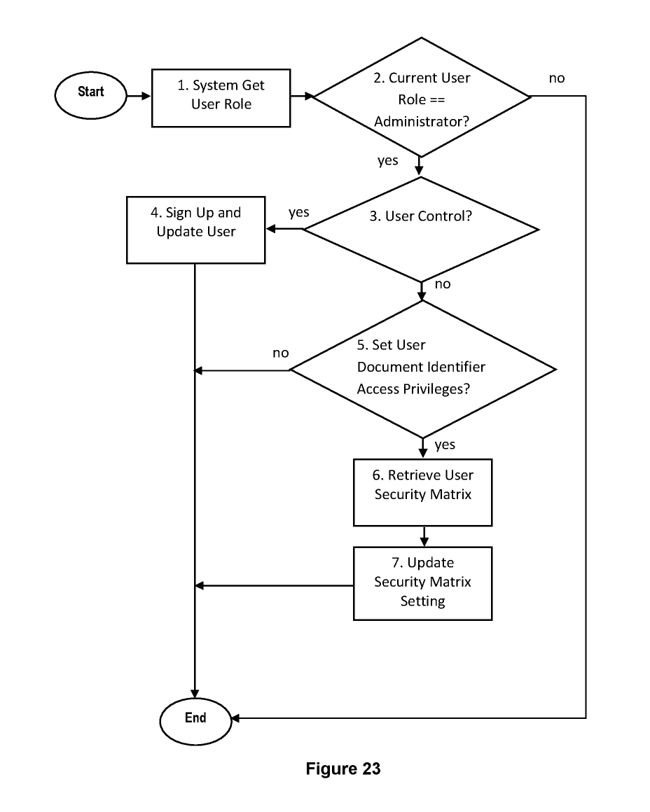

FIG. 23 illustrates a flow chart of a Electronic Business Processing sub-Module (eBPM) to performs system setting control on User Control or Document Identifier Access Privileges.

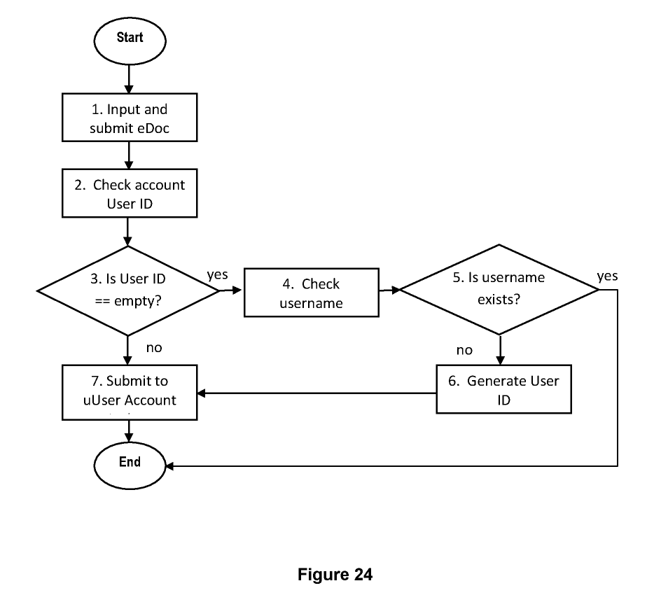

FIG. 24 illustrates a flow chart of a Electronic Business Processing sub-Module (eBPM) to performs Sign Up for new User Account and Edit existing User Account.

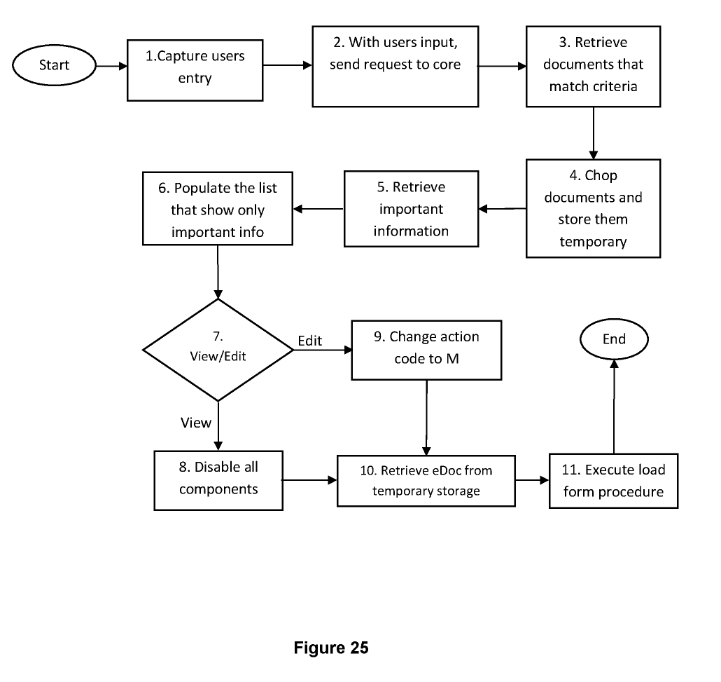

FIG. 25 illustrates a flow chart of a Enquiry Module for retrieving a pluralities of Electronic Document (eDoc) information based on at least one Information having at least one file history display into at least one list form.

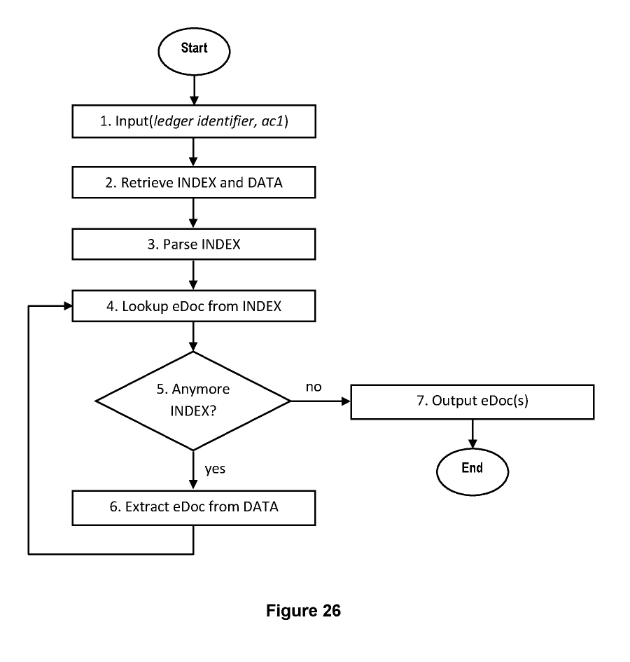

FIG. 26 illustrates a flow chart of a Enquiry Module for processing the Enquiry based on INDEX (indexes) and DATA.

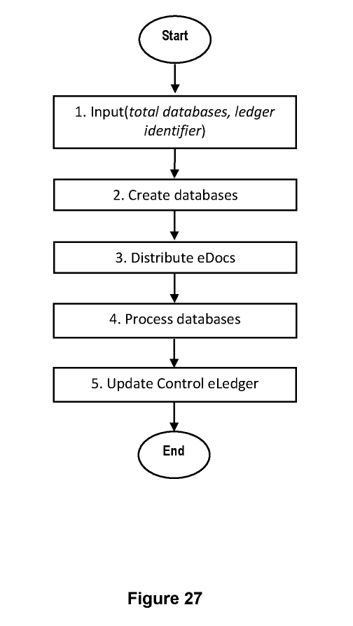

FIG. 27 illustrates a flow chart of a Parallel Processing Module.

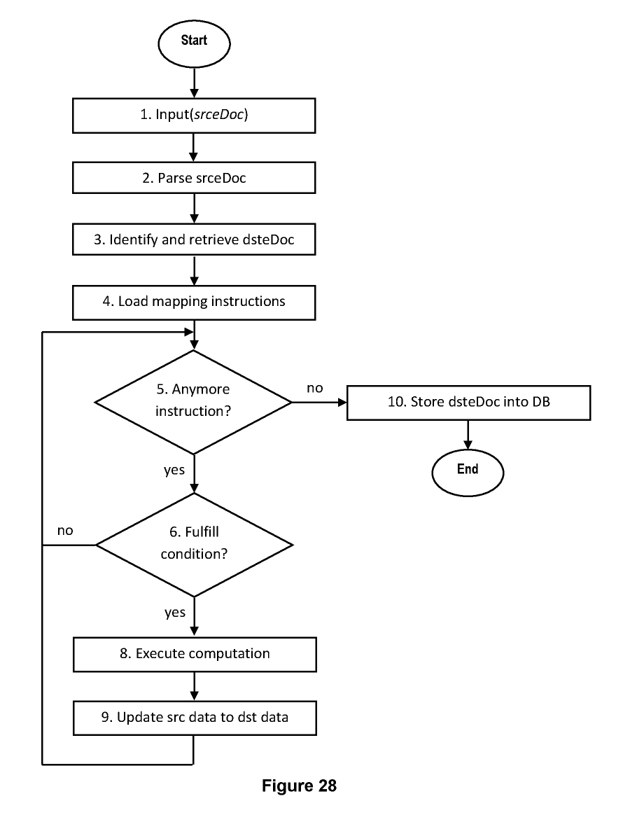

FIG. 28 illustrates a flow chart of a Mapping Processing Module.

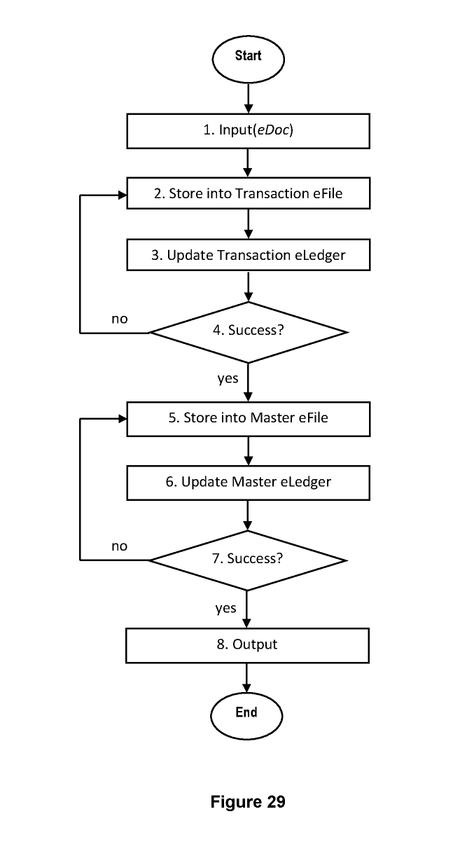

FIG. 29 illustrates a flow chart of a Transaction Processing Module.

### DETAILED DESCRIPTION OF THE PREFERRED EMBODIMENTS

The proposed invention relates to a system and method to emulate manual filing system by storing and processing document that operates on Relational Database Management System (RDBMS).

Data is stored in a format called Electronic Document (eDoc), which serves as the display, storage, processing, and transmission format throughout the systems development life cycle, without transformation at any stage. Data can be imported from or exported to any format including PDF, XML, XLS and CSV.

An Electronic File (eFile) stores eDocs (with all data file types) on a database (RDBMS). Filing System predominantly utilizes the database read, write and index functions only. Therefore it can utilise almost all popular RDBMS, and if necessary can handle any customized, in-house database systems.

As illustrated in FIG. 1, the system to emulate manual filing system for storing and processing document that operates on Relational Database Management System (RDBMS), comprising ; a String Template (1) having at least one details of document number, number of sections and number of rows defined based on at least one Input; a String Module (2) for generate a Electronic Document (eDoc) (11) having at least one Electronic Document Identifier (eDoc-Identifier), Section, Rowtype and Column by validating the document number, number of sections and number of rows based on the String Template (1); and a Extraction Module (3) for extracting the Electronic Document Identifier (eDoc-Identifier), Section, Rowtype and Column of Electronic Document (eDoc) (11) generated by the String Module (2) for retrieval process. The system also includes a Retrieval Module (4) for retrieving at least one Retrieved Data from the data of Electronic Document (eDoc) (11) stored in the database based on at least one Input of the Section, Rowtype and Column; a Updating Module (5) for updating the Retrieved Data of Electronic Document (eDoc) (11) and store at least one Updated Data to the database based on the Input of Section, Rowtype and Column defined; and a Formation Module (6) for forming the updated Electronic Document (eDoc) (11) by retrieving the Updated Data based on the Input of Section, Rowtype and Column. Further, the system has a Paging Module (7) for append Electronic Document (eDoc) (11) in the database into at least one Electronic File (eFile) (13) according to a predefined Page limit; a Indexing Module (8) for forming at least one Index to the Electronic File (eFile) (13) based-on document identifier, date, end sequence number, document status, document offset and document length; and a Read Module (9) for retrieving the Index and at least one Data Page Zero of the Electronic File (eFile) (13) based on at least one Read Input to at least one Output. In addition the system further includes a Mapping Module (10) for updating at least one Retrieved Data based on at least one Mapping Input by determining the Electronic File (eFile) (13) using the Read Module (9) to retrieve the Retrieved Data of Electronic Document (eDoc) (11) using the Retrieval Module (4), in which the Updating Module (5) update the Retrieved Data to the database and forming the Retrieved Data into the Electronic Document (eDoc) (11) using the Formation Module (6) for updating into at least one Electronic File (eFile) (13) using Paging Module (7) and forming at least one Index using the Indexing Module (8); and a Enquiry Module (14) for retrieving a pluralities of Electronic Document (eDoc) (11) information using a Mapping Module (10) based on at least one Information for the Electronic Document Identifier (eDoc-Identifier), Section, Rowtype and Column of Electronic Document (eDoc) (11), in which the retrieved Electronic Document (eDoc) (11) information having at least one file history display into at least one list form.

eDoc Filing System account-centric system that acts as a display, transmission, storage and processing medium from end to end without requiring any other transformation or normalization.

Electronic File (eFile) is an electronic folio (similar to a file in conventional manual filing systems) where all types of documents with different data types can be stored together in an account-centric manner.

The Filing system logically stores all data and information that relate to a single account in an Electronic File (eFile), in chronological order. The Electronic Document (eDoc) are stored as sequential strings of data mapped to a data dictionary, and may include multiple data types in each string (e.g. image files, binary files, comma separated format, XML or any of the nearly 500 data formats in existence today). This allows the storage of any type of data within one record. The way eDoc stores its data provides near real-time data mining without the need for data modeling.

eDoc is a data storage format comprising strings containing multiple rows each preceded by a unique row code: RxxV-Rxx being the row# and V the version#. Multiple rows of data of various rows make an eDoc. All data is stored in variable length or fixed length columns. Each row contains multiple columns separated by terminators. There are special terminators for start and end of DxxV (documents), RxxV (rows), etc. eDoc is designed for change. Various versions of RxxV and DxxV can exist concurrently. eDoc can be converted to XML and vice versa. eDoc is similar to XML as its data also has separators and identifiers and tags, but eDoc has additional system fields that provide new functionality. If required, XML is used as a universal transmission document and passed to other systems, where data can be normalized to tables. The table 1.0 and 2.0 further describes the terminators (separator) and identifiers and tags.

eDoc String

Example of eDoc String -Data Structure: (store in LxxV)

üDxxVû

üSxxVû

üRID0ûûûûûûûûûûûûûûûûûûûûûûûüRû
üRxxVûûû ... ûûûüRû
...
üRxxVûûû ... ûûûüRû

üSû
...
üSxxVû
...
üSû

üDû

Terminators (Separator) Coding Structure

TABLE 1.0
Basic Separator

| Code | Separator | Example |
|---|---|---|
| üDxxVû | Start Document | üDJS4û- start of Job sheet |
| üDû | End Document | üDû |
| üSxxVû | Start Section | üS001û- start of 1^{st} Section |
| üSû | End Section | üSû |
| üRxxVû | Start Row | üRNA1û- start of Name/Address Row v1 |
| üRû | End Row | üRû |
| u | Field Separator | ûfield-1û . . . ufield-n |
| y | SubField | ý sub field-1 ý . . . ý subfield-n |
| | Separator | |
| ü[ | Open Packet | ü[üDJS1 . . . open packet for subDoc of |
| | | DJS1 |
| û] | Close Packet | . . . üSûüDûü]close packet for the subDoc |

LDSRC Coding Structure

TABLE 2.0

| Code | Description | Example |
|---|---|---|
| LxxV | Ledger Code | LJS4: Jobsheet Ledger version 4 |
| DxxV | Document Code | DJS4: Jobsheet Document version 4 |
| SxxV | Section Code | S001: Section 1 |
| RxxV | Row Code | RNA5: Name Address Rowtype version 5 |
| CxxV | Column Code | C005: Column 5 |
| VxxV | SubColumn Code | |

The Document Identifier (such as RID0) will only contain one or the whole Document, in which the Document Identifier is stored in the first Section. The Document Identifier contains details such as creator details, document details, update history, attributes and etc. Furthermore, the eDoc String data structure is also an Nth-dimension data structure where another eDoc String can be encapsulated within the ü[ . . . ü] and stored in a Column. The LDSRC Codes is also representing the GIS of an eDoc String stored. To retrieve the eDoc String, the LDSRC Codes are used to locate them.

Example of eDoc String: (Store in LHR0)

üDHR1û

üS001û

üRID0ûdxxvû1ûUûLHR0ûLD08003ûûûDHR1ûCûûûûûûûId1302
EûLeave Applicationû12/12/2013ûûûû,&-. ~~~~ûüRû
üRNA5ûû1ûUûûûûûûûûûûûUploadûûûûûûNurul
AfizabintilbrahimûLot No. 4 LrgKingland 1, TmnKingland Phase
2, 88100 Petagas, KKûMalaysiaûNurulAfizabintilbrahimûDato
Sri MikeûSisterû016-8451196ûûIT
SUPPORTûFizaûûûûûûûûûû8ûSUPPORTûûûûûûûûûû1430996
7û830430-12-5720ûûû454 101 9729û61692683û830430-12-
5720û2000û2500û500ûûûûûûcobraangels@gmail.comûûûûûûû
ûûûûûûûû20Oct08û20Jan09û29/11/2013û28/11/2013ûûûûûûûûû
ûûûûûûûûûûûûûûûûûûûûûûûPETALING JAYAûûûûûûû014
3757463ûûûûûûûûûûûJunior Server
AdministratorûûûûûûûFemaleûûokûokûokûRecommendedûûûû
OTHERSû4.0û12ûûûû11.0û09/12/2013û1ûUûCREATIVEûûûû0
0000036ûProject Loanûûûûû(,’,)~~~ûüRû
üR133ûû1ûûûûûûûûûûûûûûûûû2û2û2013ûûûD318ûALûûûûûûû′
′,(~~~~ûüRû
üRRpD1ûû1ûûûûûûûûûûûûûûûûûûûûûûûûûûtesting approve
10.40ûûûûûûûûûûûûûûûûûûûûûûûûûûûûûûûûûûûûûûûûûûûûûû
ûûûûûûûû04/12/2013ûûûûûûûûûûûûûûûûûûûûûûûûûûûûûûûûûa
aaaaaaaûûûûûûûûûûûûûûûûûûûûûûûûûûû111ûûûûûûûûûûûûûû
ûûûûûûûûûûûûûûûûûûûûûû*&&-~~~~ûüRû
üR134ûD313û1ûûûûûû1640ûûûûûûûûûûûû1640û2014ûûûûPER
SONALLOANûû

ü[

üDHR1ûüS001ûüRID0ûdxxvû1ûUûLHR0ûLD0800
3ûûûDHR1ûCûûûûûûûId1302EûLeave
Applicationû12/12/2013ûûûû,&-. ~~~~ûüRû
üRR134ûD313û1ûûûûûû1640ûûûûûûûûûûûû1640
û2014ûûûûPERSONALLOANûûûûûûû(′-
+~~~~ûüRûüSûüDû

ü]

ûûûûû(′-+~~~~ûüRû

üSû

üDû

eDict

As illustrated in FIG. 2, the Electronic Dictionary (eDict) or metadata is used to describe the attribute/behavior of each ledger (LxxV), document (DxxV) and Rowtype (RxxV). For LxxV level, the ledger identifier, eDoc updating methods (FIFO, LIFO, Update or Overwrite) and number of eDoc to be kept in eLedger is predefined in Ledger type eDict. For DxxV level, the document type to be or can be stored is predefined in the Document type eDict. For RxxV level, the Rowtype type eDict is categorized into 3 parts; first, general attributes such as name, data type, data length and so forth; second, display attributes such as font type, size, color and so forth; third, computation attributes like data validation and computation. The table 3.0, 4.0 and 5.0 shows an example of metadata or library predefined for Ledger, Document and Rowtype.

Ledger eDict—Definition

TABLE 3.0
Dictionary

| # | Name | Function | Length | Description |
|---|---|---|---|---|
| 1 | row | data | 4 | RDL0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Ledger (LXXV) |
| 7 | ac2 | data | 16 | |
| 8 | proj | data | 4 | Project |
| 9 | datatyp | data | 1 | |
| 10 | usg | data | 1 | |
| 11 | opt | data | 1 | |
| 12 | subfield | data | 4 | |
| 13 | nm1 | data | 32 | Ledger name |
| 14 | nm2 | data | 32 | Update method (FIFO/LIFO/U/O) |
| 15 | le | data | 2 | Max document |
| 16 | de | data | 1 | |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Document eDict—Definition

TABLE 4.0
Dictionary

| # | Name | Function | Length | Description |
|---|---|---|---|---|
| 1 | row | data | 4 | RDD0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | Doc (DXXV) |
| 7 | ac2 | data | 16 | |
| 8 | proj | data | 4 | Project |
| 9 | datatyp | data | 1 | File type (Excel/Email/bin/eDoc) |
| 10 | usg | data | 1 | |
| 11 | opt | data | 1 | |
| 12 | subfield | data | 4 | |
| 13 | nm1 | data | 32 | Document name |
| 14 | nm2 | data | 32 | |
| 15 | le | data | 2 | Size of Doc |
| 16 | de | data | 1 | Version |
| 17 | def | data | 16 | |
| 18 | hid | data | 10 | |
| 19 | htag | data | 4 | |
| 20 | htype | display | 4 | |
| 21 | hstyle | display | 255 | |
| 22 | lig | data | 255 | |
| 23 | dup | entry | 1 | |
| 24 | msk | display | 200 | |
| 25 | cond | compute | 255 | |
| 26 | comp | compute | 255 | |
| 27 | next | compute | 4 | |
| 28 | der | data | | |
| 29 | mnle | validate | 2 | |
| 30 | mxv | validate | 14 | |
| 31 | mnv | validate | | |
| 32 | res1 | reserved | | |
| 33 | res2 | data | 4 | |
| 34 | res3 | reserved | | |
| 35 | res4 | reserved | | |
| 36 | res5 | reserved | | |
| 37 | bal | data | | balance |
| 38 | size | data | | Size of this row |
| 39 | secu | data | 8 | Security |
| 40 | cksum | data | 8 | Checksum |

Rowtype eDict—Definition

TABLE 5.0
Dictionary

| # | Name | Function | Length | Description |
|---|---|---|---|---|
| 1 | row | data | 4 | RDC0 |
| 2 | doc | data | 4 | Document (DxxV) |
| 3 | sq | data | 4 | Sequence# |
| 4 | st | data | 2 | Status |
| 5 | lg | data | 4 | LD10 |
| 6 | ac1 | data | 16 | RowCol (RxCx) |
| 7 | ac2 | data | 16 | |
| 8 | proj | data | 4 | Project |
| 9 | datatyp | data | 1 | Data (9/A/X/B/D/T) |
| 10 | usg | data | 1 | Usage (C/Blank) |
| 11 | opt | data | 1 | Optional |
| 12 | subfield | data | 4 | Subfield |
| 13 | nm1 | data | 32 | Label |
| 14 | nm2 | data | 32 | Name of column |
| 15 | le | data | 2 | Max Length |
| 16 | de | data | 1 | Decimal (2 dec) |
| 17 | def | data | 16 | Default |
| 18 | hid | data | 10 | HTML ID |
| 19 | htag | data | 4 | HTML Type |
| 20 | htype | display | 4 | # of elements |
| 21 | hstyle | display | 255 | Font, x, y, etc |
| 22 | lig | data | 255 | URL |
| 23 | dup | entry | 1 | Duplicate |
| 24 | msk | display | 200 | Mask |
| 25 | cond | compute | 255 | Condition |
| 26 | comp | compute | 255 | Computation |
| 27 | next | compute | 4 | Tab index |
| 28 | der | data | — | Derived Data |
| 29 | mnle | validate | 2 | Minimum length |
| 30 | mxv | validate | 14 | Maximum value |
| 31 | mnv | validate | | Minimum value |
| 32 | res1 | reserved | | |
| 33 | res2 | data | 4 | Section |
| 34 | res3 | reserved | | |
| 35 | res4 | reserved | | |
| 36 | res5 | reserved | | |
| 37 | bal | data | — | |
| 38 | size | data | — | Size of this row |
| 39 | secu | data | 8 | Security |
| 40 | cksum | data | 8 | Checksum |

Example of eDict Structure

üDDR0û
üS001û
<--------------------- 40 columns in horizontal representation ---------------------------
-->
üRDC0û doc û sq û st û lg û ac1 û ac2 û proj û datatyp û usg û^opt û subfield
û nm1 û nm2 û le û de û def û hid û htag û htype û hstyle û lig û dup û msk û
cond û comp û next û der û mnle û mxv û mnv û res1 û res2 û res3 û res4 û
res5 û bal û size û secuû cksumüRû
üSû
üDû

eLedger

Electronic Ledger (eLedger) is where summaries or derivatives of eFile that is kept in variable length or fixed length format thus allowing for greater flexibility and fast retrieval. The Information in eLedger can be deleted and modified. Each eFile can have multiple eLedgers if required (for speedy reporting purposes). The update method of each eDoc to the eLedger is predefined in eLedger dictionary. The eLedger can contain n copies of eDoc that arrange in FIFO or LIFO manner; or new eDoc can override the exiting eDoc in the eLedger; or the update only manipulate data from certain column(s) in eDoc with the predefine column(s) in eLedger. The system may further include Zero Balancing function where every transaction can be traced and no information is ever deleted, which means everything will be balanced (always balance to last cent). All transactions have a copy in the Transaction Ledger, so changes to any account are immediately verifiable and problems isolated. The system also may make the system naturally SOX Compliant (Sarbanes-Oxley Act of 2002). The system may further include Reverse Processing where a new eLedger can be generated or regenerated from eFile based on new configuration or updated configuration.

As illustrated in FIG. 3, the eLedger contains example customer profile that includes customer details (RNA6—Name and Address Rowtype) and summary of total item such as apple, orange and pear bought daily (R320—32-day Rowtype) and monthly (R130—13-month Rowtype) for year 2014. The summary in the eLedger are populated from the daily transactions in eFile.

Rowtype Header & Footer

TABLE 6.0

| sq | name | description |
|---|---|---|
| 1 | RxxV | rowtype |
| 2 | RWCD | row code |
| 3 | RWSQ | sequence |
| 4 | RWST | status |
| 5 | RWLG | ledger |
| 6 | RWA1 | account 1 |
| 7 | RWA2 | account 2 |
| 8 | RWCO | company & department |
| . . . | . . . | |
| n + 1 | RWBA | balance |
| n + 2 | RWSZ | size |
| n + 3 | RWSE | security |
| n + 4 | RWCS | checksum |

All Rowtype contains a Header with 8 columns and a Footer with 4 columns as shown on the Table 6 above. The row code (RWCD) of the Rowtype Header indicates its uniqueness among other same Rowtypes that appear within a Section and ledger (RWLG), account 1 (RWA1), account 2 (RWA2) and company & department (RWCO) indicates the location of the Rowtype in the database. The security (RWSE) of the Rowtype Footer is used to ensure that the right user(s) can access this row and the checksum (RWCS) is to ensures the data within the row is not corrupted.

Subsequent Documents (SubDoc)

As illustrated in FIG. 4, the creation of Subsequent Documents (subDoc), where the system splits a Doc so that it can be debited/credited to relevant account, each subDoc is appended as a string one after another. The Main Doc and subDoc(s) will have the same document identifier. For example, an invoice with document identifier, D232 may have a subDoc to debit customer account and subDoc to credit Apple, Orange and Pear Stock. (Referring to the example in FIG. 2).

Reserve and Commit

It's a process where a set of predefined requirements have to be adhered before any updating can take place. For example in an invoice, the requirements will be the customer must have sufficient credit to be debited from the account and there must be sufficient stock to be stocked out before the process is committed.

Header+Index+Data

As illustrated in FIG. 5, the eFiles are stored in a RDBMS table, where the table comprises of Control, Index and Data. The Control section contains key and details about the Page. The Index is used to locate the location of each eDoc in a Page, where the Indexing are done in Horizontal manner to create sub-filing system within a filing system. The Data is where the eFile is stored.

Example of Index for Account 1, Relative Page is as below:

DHR0:20140828: 5: U: 0: 122/DHR0:20140828: 6: U: 122: 250/DHR0:20140828: 7: U: 250: 372/

Each account contains a eFile and the eFile contains number of eDocs. The eFile is chopped into Pages according to Page size before storing into RDBMS. The Page number begins from Relative Page and when a new Page is added, the Relative Page is advanced to Page 1 and the Page number of the newly added Page is 0 and so forth. Besides that, Relative Page is also a relative page to the system; the enquiry will always start from Relative Page.

The Control section may also include the following:
Ig—ledger identifier
ad—account 2
lpgn—last page no
ssq—start document sequence no
sin—start Page line no
esq—end document sequence no
eln—end Page line no
date—last updated date
st—the status of the eFile such as deleted
co—company and department
bal—balance of all eDocs

Web Processing Module

Web processing system interprets program in at least one Program Module and load a Electronic Form (eForm) to capture data entry, a form with set of instructions and data fields that pre-created and defined in the Program Module, and also displaying any requested Electronic Document (eDoc) that compatible with loading form. While user enters data into the Electronic Form (eForm), validation occurs on field pre-defined in Electronic Dictionary (eDict), which will alert the user and guide the user entering the data, and perform eForm LLG (library of pre-defined program to assist user on data entry) based on user's trigger.

On user's trigger or input, the eForm will captures and save data from form into eDoc, and pass to Electronic Business Processing Module (eBPM) for flow control, mapping and storing into Electronic Filing (eFiling) system.

Electronic Browsing Filing System (eBFS) is a client storage system. The main objective is to achieve faster eDoc retrieval, and able to remain functional even the system has no access to Internet.

The eForm provides an electronic form with tools to capture new insert data, manipulate form, and also eDoc formation. The system able to read and load predefined Program (eProgram) from database into eForm. Furthermore, it able to save data, form into eDoc and store into database.

It provides tools, for example eForm functions that have more variety options to access and manipulate eDoc and eForm. For example, real-time loading or saving eForm, fetching eDocs from database and populating the eDocs into table, etc. The Data validation will ensure data inserted is adhered to the predetermine formats.

Communication Processing Module

From the Row Identifier, the type of process is identified and the Electronic Document (eDoc) will be directed to the requested process. The Electronic Document (eDoc) is directed to any processed without a single data transformation.

Online Processing Module

All transactions are stored into database in real-time. By the end of each business day, the scheduled Sarbanes-Oxley (SOX) compliance process will kick in to ensure that the total sum of the transactions for the day stored in Transaction Electronic Ledger (eLedger) is equals to the sum of the transactions for the day stored in Master eLedger. If there is a missing transaction in the Master eLedger, the missing transaction will be recovered from the Transaction eLedger.

Batch Processing Module

All transactions will be verified through the Sarbanes-Oxley (SOX) compliance process before storing into database. The process will sum the balance of each transaction from the batch and compare the total sum with the pre-summed value from the batch header. If the total sum and pre-summed value is tally, the entire batch of transactions will be stored into database. If otherwise, an error message will be prompted.

Storage Processing Module

The transaction (eDoc) is stored into database through Paging Module and Index Module. Each eDoc will be appended to the Electronic File (eFile) and if the eFile length is longer than the Page Limit, the excess of the eFile will be stored into next Page(s). The Index will be created for each eDoc that has been appended to eFile. The eDoc Read Module will rely on the Index created to locate the eDoc required.

Electronic Business Processing Module

The System able to perform Electronic Business Processing Module (eBPM) process by reusing the same document. The document information is stored in eDoc. During system operation, same document(s) are circulating for execution according system flow in Business Processing Module (BPM).

Electronic Business Processing Module (eBPM) will govern the process/system flow of the IT system/software. From the master system flow information, System will identify the task sequences. If current task is the first/new task, System will create an operation workflow ID. For non-first task, System will update the existing operational workflow status. Then, System will process the next task of the operational workflow for user execution. It supports metering features and enable user to know the status and progress of any task in every single processes.

User will select the application to launch. System will load tasks to be executed by user. System will check user role before execute the task. When user submits task, system will retrieve the master system flow information from Ledger Identifier and Document Identifier. Then, the submitted task which is eDoc will be stored in temporary memory. Once all the task are completed in a single process, the completed task will be updated to the master ledger.

The Electronic Business Processing Module (eBPM) task is generated as program and stored in eDoc.

User security matrix is created to enable user to read, write, update and delete for every Electronic Business Processing Module (eBPM) task. Every task in Electronic Business Processing Module (eBPM) process is governed by user security matrix.

The eBPM task assignment details are stored in eDoc. Since BPM task is stored in eDoc, User can assign/unassign task by circulate the eDoc. In eBPM task management, user can create, execute, update and delete task.

Every stage in eBPM process is metered and stored in eDoc. This enable fast eBPM Metering enquiry because user can enquiry every task metering information directly from eDoc, without required any data manipulation to display task metering information to user. The eBPM Metering enable user perform enquiry by account and application level. User can enquiry task metering information by enter account or application information.

Enquiry Processing Module

By virtue of eDocs are stored in the structure manner (Ledger-Document-Section-Row-Column coding structure), the eDocs can be retrieved in a fast manner through the one and only one Enquiry Processing. From the user input, ledger identifier and account 1, all the related eDoc(s) will be retrieved from database using the List and Zoom Module. User can zoom into each eDoc by clicking the eDoc from the list.

Parallel Processing Module

The nature of Account-Centric Storage System has enabled the easy distribution of each account to different database at different location. For high speed processing, each database can have dedicated computing resources to process the eDocs that belong to each account.

Each account can be distributed to either 10, 100 or 1000 databases based-on the last, last 2 or last 3 digit(s) of the account number. The parallel processing will process all databases concurrently. By the end of the process, the result from each process will be updated to the Control Ledger to form the final summary.

Mapping Processing Module

The input data is updated into the database through the predefined Mapping Instruction(s). Each Mapping Instruction will indicate either the update is at document, row or column level. At the column level, the Mapping Instruction might contain condition validation and/or computation before the data is being updated into the database.

ACID (Atomicity, Consistency, Isolation, Durability) Processing is a process that guarantees that transactions are processed reliably before updating to the database. The ACID Processing will be applied during the Mapping Processing whenever it's required. For example, a transfer of funds from one bank account to another, even involving multiple changes such as debiting one account and crediting another, is a single transaction.

Transaction Processing Module

The Transaction Processing will ensure that any eDocs that are to be stored into the database is Sarbanes-Oxley (SOX) compliance. This is achieved by making sure that the status of each storing and updating process is reported back to Transaction Processing; for this case, eDoc sequence number is used. The process is considered complete when the storing and updating at Transaction eFile and eLedger and Master eFile and eLedger are executed sucessfully.

As illustrated in FIG. 6, the Web processing system will retrieve predefined Program (eProgram) in a Program Module from database and load it into Electronic Form (eForm), which enable data entry of at least one user input (101). Then, the system Check if eDoc available and require to display in eForm (102). If eDoc available, run eDoc loader to retrieve and load eDoc and its data into eForm (103). The eForm's data entry consist of set of rules and tools that assist user on entering valid and useful data, rules include certain type, length, size, value, format and more for entering data, while tools include (eForm functions—LLG) that will perform various action that assist manipulating eForm and eDoc (104). Further, eForm will save all data user entered on the eForm, pass through some checking and verification, and will form these data into an eDoc (105). At this stage, check if current working eForm in flow control by Electronic Business Processing Module (eBPM) (106). If the eForm in flow control by Electronic Business Processing Module (eBPM), the eForm will be process by Electronic Business Processing Module (eBPM) (107). If the eForm not in flow control by Electronic Business Processing Module (eBPM), the complete eDoc will pass to eBFS to control the flow to store into database (108).Then, eDoc will be pass to TP(Transaction process) to be store into database (109).

As illustrated in FIG. 7, the predefined Program (eProgram) in a Program Module of Web processing module from database and load it into Electronic Form (eForm) further includes steps of; document identifier for loading document (201). Using read module, retrieve predefined Program (eProgram) in a Program Module with document identifier (202). Then, check if the predefined Program (eProgram) in a Program Module exists in database (203). If loading predefined Program (eProgram) in a Program Module is not exists in database, eForm error handler will report faulty to user (204). If loading predefined Program (eProgram) in a Program Module is exists in database, then it retrieved predefined Program (eProgram) by read module, eProgram loader will load the pre-created eProgram into eForm (205).

As illustrated in FIG. 8, the Web processing module initiates the User proceeds to perform data entry by entering data into loaded Electronic Form (eForm) to complete for the transaction or document (301). Electronic Form (eForm) may contains instructions that invoke eForm functions (LLG) to perform various action that may manipulating eForm and processing eDoc, for example load eForm, save eForm, fetching eDoc from database, sum up several targeted elements to targeted element, and etc (302). The data entry by user will go through validation to check these data from a set of rules that pre-defined in the system (303). Then, the system will check if data valid for pre-defined format and rules (304). If data valid for pre-defined format and rules is valid, then for every data which has pre-defined instruction that requesting for data computation, the eForm will compute these data with pre-defined instructions (305).

As illustrated in FIG. 9, the Web processing module will retrieve all data entered in loaded eForm (401). Then, identify these data retrieved to clarify the information on the data, and location of these data will be store (402). These data will go through predefined validation to ensure data are valid information (403). Further, the system checks if data pass through eForm data validation and proven if data is valid (404). With all these data, retrieved, identified and validated, group together and build into eDoc (405). If data is not valid, prompt faulty to user (406).

As illustrated in FIG. 10, the Communication Processing system firstly receiving eDoc to start the process (501). Then, the system will identify the process from row identifier that stated in the eDoc using Retrieval Module (502). Further, validate the process from row identifier (503). If not valid, the system will trigger output error message (504). If valid request, the system will direct eDoc to the requested process for further processing (505).

As illustrated in FIG. 11, the Online Processing system will receive ledger identifier, document identifier, date and time to start the process (601). Then the system will delay the process till the predefined date and time (602). Then, start sum the data of predefined field(s) from eDocs from the predefined document identifier in Transaction eLedger (LT10) and Master eLedger(LM) based on the last processed date and time. The eDocs are retrieved using the Read Module and each field(s) from eDocs are retrieved using the Retrieval Module (603). Thereafter, the system compares the summed value(s) (604). Then, validate if the summed value(s) from LT10 and LM is/are tally (605). If summed value(s) is not tally, locate the missing eDoc in LM from LT10 and store and update the missing eDoc into LM through Transaction Processing Module; the process carries on till the sum is tally (606). However, if summed value(s) tally, update the process completion date and time to the process log (607).

As illustrated in FIG. 12, the Batch Processing system will obtain a batch of eDocs (701). Then, extract pre-summed balance(s) from the batch header for later comparison (702). The sum the data of predefined field(s) from eDocs. Each field(s) from eDocs are retrieved using the Retrieval Module (703). Then, compare the summed value(s) with pre-summed balance(s) (704). Thereafter, validate if the summed value(s) and pre-summed balance(s) is/are tally (705). If summed value(s) and pre-summed balance(s) is/are tally, store the entire batch of eDocs to Transaction Ledger (LT10) and Master Ledger (LM) using Transaction Processing Module (706). However, if summed value(s) and pre-summed balance(s) is/are not tally, the system will prompt output error (707).

As illustrated in FIG. 13, the storage processing system will receiving ledger identifier, document identifier, account 1 and account 2 and eDoc from a program (801). Then, validate with the database if this account is a new account (802). If it's not a new account, retrieve the existing Page from the database for later processing (803). Then, append eDoc form input to the eDoc from Page (804). However, if it's a new account, the system further validate if the length of the combined eDoc is greater than the Page limit(805). If the length of the combined eDoc is greater than Page Limit, chop the combined eDoc into x Pages according to Page limit (806). On the other hand, if the length of the combined eDoc is not greater than Page Limit, each Page Index will be formed base-on document identifier, date, end sequence no, document status, document offset and document length (807). Finally, storing Page and Index into database (808).

As illustrated in FIG. 14, the Storage Processing system used for Indexing will receive document identifier, date, end sequence no, document status, document offset and document length from a program (901). Then, form Index by combining all input as a string and each input is separated by colon (:) (902). Finally, the system returns the formed Index to the program that triggered this operation (903).

As illustrated in FIG. 15, the Storage Processing system used for Reading eDoc from database will receive ledger identifier, document identifier, account 1 and account 2 from a program (1001). Then, retrieve INDEX (indexes) and DATA of Relative Page for a given account from a eFile from the database (1002). Then, parse INDEX into individual index (1003). Thereafter, lookup index that contains document identifier from the input received (1004). The, verify if there is any document identifier is found (1005). if document identifier is not found, validate if there are more indexes (1006). If there are more indexes, lookup index and further verify if there is any document identifier is found. However, if document identifier is found, from the index found, retrieve the offset and the length of the target eDoc. Then extract the eDoc from DATA (1007). Finally, the system output eDoc found (1008).

As illustrated in FIG. 16, BPM Processing system used for User Login Authentication and Process Control requires User to key in username and password as log in details (1101). Then, the System will retrieve the log in details (1102). Then, the system validates the login detail with the login details defined in the database (1103). If the login details are valid, the System retrieves security matrix control setting by using Web-Read Module. The security matrix is user access privileges (read, write, update and delete) on the Document Identifier (1104). Then, the System places control on task by using at least one predefined program (1105).

As illustrated in FIG. 17, the BPM Processing system used for Process Control requires the User selects and enters the application from the menu (1201). Then, the System displays pending and complete task list for user action by using Web-Read Module (1202). Thereafter, the User selects task by using Web-Read Module, where the System checks whether any Document Identifier from previous task, then System will load that particular Document Identifier. If there is no Document Identifier from previous task, System will load the new Document Identifier for user (1203). Then, the System will load the task from Web Processing program (1204). Once user submitted task, System will retrieve eDoc from Web Processing program (1205). Finally, the System will perform save task program (1206).

As illustrated in FIG. 18, the BPM Processing system used for Process Control to retrieve the master process flow information by using Web-Read Module (1301). Thereafter, the system will retrieve the master process flow eDoc, the system further validates process flow using Retrieval Module. Then, the System will save user submitted task by using Transaction Processing Module (1302). Then, validate the submitted task by using Web-Read Module (1303). If System identified current task is new task in the workflow, create a new operational workflow ID for this process by using Web-Read Module (1304). However, if System identified current task is not new task in the workflow, System will update current task in operational workflow metering status by using Updating Module. Then, System will save to database by using Transaction Processing Module (1305). In task metering, the System will update task status in the process. Thereafter, the System will retrieve next task setting by using Read Module. Then, System generates the task accordingly and saves to database by using Transaction Processing Module. If next task is Condition, System will perform condition evaluation. If the particular conditions/business rules are valid, System will generate next task and saves to database by using Transaction Processing Module (1306). Then, Validate if task reached end of the process (1307). If current task reached end of the process, System submits and updates all the completed tasks in operational workflow to master Ledger by using Transaction Processing Module and Mapping Module (1308).

As illustrated in FIG. 19, the BPM Processing system used for User Login Authentication and Metering Enquiry requires User to key in username and password as log in details (1401). Then, the System will retrieve the log in details (1402). Then, the System validates the log in detail with the login details defined in the database (1403). Thereafter, the System retrieves security matrix control setting by using Read Module (1404). Finally, the User performs metering enquiry by program (1405).

As illustrated in FIG. 20, the BPM Processing system used for Display metering result and task management enquires, where the User inputs the parameters to enquiry the targeted result. The input parameters examples are workflow ID, user ID, duration and date and save in eDoc format (1501). Then, the System will parse the input by using Retrieval Module then send to enquiry program (1502). Thereafter, the System will generate task metering result based on the enquiry criteria (input parameters). The result will be retrieved by Read Module and display to user (1503). Then, the system Validate if the user selects any task management for assign or unassign task (1504). If user selects task management to assign or unassign task, System will load Manage Job program (1505). However, if user does not select any task management to assign or unassign task, the system will end.

As illustrated in FIG. 21, the BPM Processing systems used for update Task Status by retrieve user role (1601). Then, the System will retrieve user selected task information by using Web-Read Module (1602). Verify if the user would like to update task status (1603). If user updates task status, then System will proceed to update task status by using Updating Module, and then save to database by using Transaction Processing Module. System will perform task status update when user create, execute, update and delete a task (1604). However, if user does not update task status, then verify if user would like to assign or unassign task (1605). If user assigns or unassigns task, System will check user role. In this case, if the current user role rank is authorised, then user is allowed to do task assignment. For example, Manager role rank is higher than Support. If a task can be executed by Support role and above, Manager is allowed to assign the task (1606). Then, the System will update task setting and assign the task to user by using Updating Module, then save to database by using Transaction Processing Module (1607). However, if user does not assign or unassign task, the system further verify if user would like to edit task (1608). If user edits task, System will update task edit details such time, duration and User ID by using Updating Module, then save to database by using Transaction Processing Module (1609). However, If user does not edit task the system terminates.

As illustrated in FIG. 22, The BPM Processing system used for User Login Authentication and System Setting, where, the User needs to key in username and password as log in details (1701). Then, the System will validate the log in details (1702). Verify if log in details is valid (1703). Thereafter, the System retrieves security matrix control setting by using Web-Read Module (1704). Then, User performs system setting control by predefined program (1705).

As illustrated in FIG. 23, the BPM Processing System used for setting up of Setting Control, where, the System will retrieve user role (1801). Thereafter, the System will check is the current user role is Administrator. (1802). If user role is Administrator, user can performs user sign up and security matrix setting. Then, verify if user selected User Control or Document Identifier Access Privileges (1803). If user selected User Control, System will load Sign Up program (1804). If user did not selected User Control, the system further Verify, if user selected set user Document Identifier Access Privileges (1805). Then, if user sets Document Identifier Access Privileges, the System will retrieve selected user security matrix setting by using Retrieval Module (1806). Thereafter, the User can set every Document Identifier Read, Write, View and Delete access privileges by using Updating Module. Then, system submits to database by using Transaction Processing Module (1807).

However, If current user role is not Administrator, or if user does not perform Document Identifier Access Privileges, the system terminates.

As illustrated in FIG. 24, the BPM Processing system used for Sign Up new User Account and Edit existing User Account, where, the User inputs and submits the account in eDoc to System (1901). Thereafter, the System will check User ID in account eDoc by using Retrieval Module (1902). Verify if the user would like to perform sign up by determining User ID in submitted account eDoc is empty or if the user would like to perform update user account process, if submitted account eDoc is not empty (1903). However, If User ID in submitted account eDoc is empty, the System will submit the Username in the submitted account eDoc to perform Username existence checking by using Transaction Processing Module (1904). Then, the System will read the result by using Web-Read Module. System parses the result by using Retrieval Module. If the Username does not exist, then user is allowed to create a new user account (1905). Then, the System generates the user ID for the new user account and saved in submitted eDoc (1906). However, If User ID in submitted account eDoc is not empty, then the submitted account eDoc is updated in the user account Ledger by using Transaction Processing Module (1907).

As illustrated in FIG. 25, the Enquiry Processing Module used for List and Zoom of document where the system capture users input for ledger identifier and account 1 (2001). Then, the system send request to Enquiry Module (2002). Thereafter, the system retrieves all documents that match criteria (2003). Then, splits into single document and store them temporary (2004). Then, retrieve key information from each documents such as creator, date (2005). Thereafter, the system will populate the documents into a list (2006). Verify if user choose to view or edit column if there is one (2007). If user chosen to view, disable all components and proceed to load the form (2008). However, if user chosen to edit load the form and change action code to editable-mode (M) (2009). Then, the system retrieve document from the temporary storage (2010). Finally, the system display the document (2011).

As illustrated in FIG. 26, the Enquiry Processing System used for process Enquiry where, initially the system receiving ledger identifier and account 1 from a program (2101). Then, the system retrieve INDEX (indexes) and DATA from database based on the input received (2102). Thereafter, parse Indexes into individual index (2103). Then, lookup eDoc using parsed index (2104). The system further validate if there are more indexes (2105). if there are more indexes found, the system retrieve the offset and the length of the eDoc. Then extract the eDoc from DATA. The process will carry on till there is no more index (2106). Finally, output eDoc(s) found (2107).

As illustrated in FIG. 27, Parallel Processing System used for Parallel Processing of documents where the system receiving instruction either to create 10, 100 or 1000 databases and ledger identifier to be processed from a program (2201). Then, create databases based on the input instruction (2202). Thereafter, distribute eDocs from the defined ledger to databases created using Paging and Index Module. The last, last 2 or last 3 digit(s) of account number is used to determine which database the eDoc to be distributed to (2203). Then, start parallel processing once all eDocs have been distributed into the designated databases (2204). Finally, the system will update the processed result to the predefined Control eLedger through the Mapping Module (2205).

As illustrated in FIG. 28, Mapping Processing System used for Execute Mapping Instruction by receiving source eDoc from a program (2301). Then, parse source eDoc for later operation using Extraction Module (2302). Thereafter, identify and load destination eDoc from the source eDoc (for later updating) using Read Module (2303). Then, load predetermined mapping instructions (2304). Validate if there are more mapping instruction (2305). if there are more mapping instruction, the system further validate if the data of the predetermined source column fulfill the predetermined requirement(s) from the mapping instruction (2306). if the data of the predetermined source column fulfill the predetermined requirement(s) from the mapping instruction, then perform computation on the data of the predetermined source column from the mapping instruction if there is one (2307). Thereafter, the system sum up the result from the computation with the data of the predetermined destination column and use the Updating Module to update the final result to the predetermine destination column. This process will be carried on till there is no more mapping instruction (2308). However, if there are no more mapping instruction, then store the updated destination eDoc back into database using Paging and Index Modules (2309).

As illustrated in FIG. 29, the Transaction Processing System used for Processing eDoc Transaction by receiving eDoc from a program (2401). Then, store received eDoc into Transaction eFile using Paging and Indexing Module (2402). Thereafter, update received eDoc to Transaction eLedger using Paging and Indexing Module (2403). Verify if Transaction eLedger updated successfully (2404). if received eDoc updated successfully, the system will store received eDoc into Master eFile using Paging and Indexing Module (2405). Then, update received eDoc to Master eLedger using Mapping Module (2406). Verify if Master eLedger updated successfully (2407). Then, if Master eLedger updated successfully, the system returning the update status (2408).

The present invention may be embodied in other specific forms without departing from its essential characteristics. The described embodiments are to be considered in all respects only as illustrative and not restrictive. The scope of the invention is, therefore indicated by the appended claims rather than by the foregoing description. All changes, which come within the meaning and range of equivalency of the claims, are to be embraced within their scope.

1.-26. (canceled)

27. A system to emulate a manual filing system by storing and processing documents that operate on a relational database management system, comprising:
an electronic document having at least one electronic document identifier, section, rowtype or column;
a program module having at least one electronic form to capture data entry based on a set of instructions and data fields that are pre-defined in at least one electronic dictionary;
a virtual memory for storing the electronic document; and
a web-read module for retrieving the electronic document from the virtual memory based on at least one identifier of the electronic document, in which the identifier is extracted based on the captured data entry of the electronic form;
wherein the web-read module for retrieving the electronic document comprises:
a paging module having the electronic document append into at least one electronic file in the relational database management system according to a predefined page limit;
an index module having at least one index for the electronic file based on a document identifier, date, end sequence number, document status, document offset or document length; and
a read module to obtain the index and at least one data relative page of the electronic file from the index module based on the identifier, in which the electronic document retrieved from the paging module based on the retrieved index and the data relative page to be stored in the virtual memory and update the index module.

28. The system according to claim 27, wherein the identifier of the electronic document comprises the electronic document identifier, section, rowtype or column.

29. The system according to claim 27, wherein the identifier of the electronic document comprises the document identifier, date, end sequence number, document status, document offset or document length.

30. The system according to claim 27, further comprising:
an enquiry module for retrieving a plurality of the electronic document information based on at least one information for the electronic document identifier, section, rowtype or column of the electronic document, in which the retrieved electronic document information has at least one file history displayed into at least one list form.

31. The system according to claim 30, wherein the list form has at least one predefined information for each document.

32. The system according to claim 30, wherein the enquiry module further comprises an editing module to load the retrieved electronic document for updating the retrieved electronic document and store at least one updated data to the virtual memory.

33. The system according to claim 30, wherein the enquiry module further comprises a viewing module to load the retrieved electronic document for viewing the retrieved electronic document.

34. The system according to claim 30, wherein the enquiry module further comprises a searching module, wherein the searching module retrieves the electronic document using the web-read module based-on at least one index, in which the index is retrieved from the identifier of the electronic document comprising the document identifier, date, end sequence number, document status, document offset or document length.

35. The system according to claim 27, wherein the web-read module further comprises an uploading module to upload the electronic document based the identifier of the electronic document, in which the uploading module establishes a connection to at least one server having the relational database management system and updates the relational database management system with the uploaded electronic document.

36. A method to emulate a manual filing system by storing and processing document that operates on a relational database management system, comprising the steps of:
retrieving a predefined program using a program module from a database;
loading the predefined program it into at least one electronic form to enable data entry of at least one user input;
verifying if an electronic document available to load electronic document data in the electronic form based on the user input;
extracting the data entry of the user input from the electronic form;
verifying the extracted data entry using the program module based on a set of rules that assist a user on entering valid data and a verification tools that assist manipulating the electronic form and the electronic document;
saving the verified data into the electronic document;
verifying if the saved electronic document has at least one flow control program defined by an electronic business processing module;
submitting the saved electronic document to the electronic business processing module to define at least one flow control;
transferring the defined electronic document to a transaction processing module to regulate the electronic document to be in Sarbanes-Oxley compliance; and
storing the electronic document in to the database;
wherein verifying if the electronic document is available to load the electronic document data in the electronic form based on the user input comprises the steps of:
retrieving the electronic document using at least one web-read module based on the user input; and
loading the data from the retrieved electronic document into the loaded electronic form.

37. The method according to claim 36, wherein the step of verifying if the saved electronic document has at least one flow control program defined by the electronic business processing module further comprises the steps of:
logging-in using predefined details in at least one login module;
retrieving the log in details;
validating the login detail with the login details defined in the database;
retrieving a security matrix control setting having user access privileges on the document identifier of the electronic document by using the web-read module; and
defining at least one task to the electronic document using at least one predefined program.

38. The method according to claim 37, wherein the step of defining at least one task using at least one predefined program further comprises the steps of:
retrieving at least one predefined task by using the web-read module;
selecting the predefined task based on a predefined task list by using the web-read module;
verifying if there is a document identifier for the electronic document from previous task;
generating a new document identifier;
loading the predefined task from a web processing program system;
retrieving the electronic document from the web processing program system; and
saving the predefined task to the electronic document.

39. The method according to claim 37, wherein the step of saving the predefined task to the electronic document further comprises the steps of:
retrieving the master process flow information by using the web-read module;
saving a predefined current task by using the transaction processing module;
validating the predefined current task by using the web-read module;
creating a new operational workflow ID for this process by using the web-read module, if the system identified current task is a new task in the workflow;
updating the current task in operational workflow metering status by using an updating module, if the system identified current task is not a new task in the workflow;
saving the current task to the database by using the transaction processing module;
verifying if the current task is completed; and
updating the completed current tasks in operational workflow to a master ledger by using the transaction processing module.

40. The method according to claim 39, wherein the step of updating the current task in operational workflow metering status by using the updating module, if the system identified current task is not a new task in the workflow, further comprises the steps of:
logging-in using predefined details in the login module;
retrieving the log in details;
validating the login detail with the login details defined in the database;
retrieving a security matrix control setting having user access privileges on the document identifier of the electronic document by using the web-read module;
performing at least one metering enquiry to the electronic document using at least one predefined enquiry program;
retrieving at least one parameters to enquiry the targeted result based on at least one user input;
parsing the input by using a retrieval module then send to enquiry program;
generating at least one task metering result based on the enquiry parameters using a read module;
validating if the user selects any task management for assign or unassign task;
loading at least one predefined manage job program, if the user selects task management to assign or unassign task;
retrieving at least one user role based on the task;
retrieving the selected task information by using the web-read module;
verifying if the user would like to update task status;
performing a task status update when the user creates, executes, updates and deletes the task;
verifying if the user would like to assign or unassign task, if the user does not update the task status;
verifying the user role based on a predefined user role ranking;
updating at least one task setting and assign the task to at least one user by using the updating module, then save the task setting to the database by using the transaction processing module;
verifying if the user would like to edit task, if the user does not assign or unassign task; and
updating the task edit details including time, duration and user ID by using the updating module, then save the task to the database by using the transaction processing module.

41. The method according to claim 39, wherein the step of saving the current task to the database by using the transaction processing module further comprises the steps of:
logging-in using predefined details in the login module;
retrieving the log in details;
validating the login detail with the login details defined in the database;
retrieving a security matrix control setting having user access privileges on the document identifier of the electronic document by using the read module;
performing at least one control setting to the electronic document using at least one predefined control program;
retrieving at least one user role based on the setting;
verifying if the current user role is an administrator;
performing user sign up and security matrix setting;
verifying if the user selected a user control;
loading a sign up program, if the user selected the user control;
verifying if the user selected document identifier access privileges;
retrieving selected user security matrix setting by using the web-read module, if the user selected set user document identifier access privileges;
setting at least one access privileges for document identifier by using the web-read module; and
saving the access privileges to the database by using the transaction processing module.

42. The method according to claim 39, wherein the step of loading a sign up program, if the user selected the user control further comprises the steps of:
retrieving at least one user ID;
verifying the user ID in the electronic document by using the web-read module;
verifying if the user would like to perform sign up by determining the user ID, if submitted account electronic document is empty;
verifying if the user would like to perform update user account process, if submitted account electronic document is not empty;
submitting the user ID in the submitted account electronic document to perform the user ID existence checking by using the transaction processing module, if the user ID in submitted account electronic document is empty;
creating at least one new user account for the user ID, if the user ID does not exist;
generating the user ID for the new user account and saved in submitted electronic document; and
updating the submitted account electronic document in a user account ledger by using the transaction processing module, if the user ID in submitted account electronic document is not empty.

43. The method according to claim 37, further comprising the steps of:
providing a communication processing module;
receiving the electronic document to start the process;
identifying the process from row identifier that stated in the electronic document using the retrieval module;
validating the process from row identifier;
triggering an error message, if not a valid request; and
directing the electronic document to the requested process, if a valid process.

44. The method according to claim 37, further comprising the steps of:
providing an online processing module;
receiving a ledger identifier, document identifier, date and time to start the process;
delaying the process till the predefined date and time;
summing the data of predefined fields from the electronic document from the predefined document identifier in a transaction eLedger and a master eLedger based on the last processed date and time;
retrieving the electronic document using the read module and each field from the electronic documents is retrieved using the retrieval module;
compares the summed value;
validating if the summed value from the transaction eLedger and the master eLedger is tallied;
locating the missing electronic document in the master eLedger from the transaction eLedger and store and update the missing electronic document into the master eLedger through the transaction processing module; and
updating the process completion date and time to the process log, if the summed value is tallied.

45. The method according to claim 37, further comprising the steps of:
providing a batch processing module;
obtaining a batch of electronic documents;
extracting a pre-summed balances from the batch header for later comparison;
summing the data of predefined fields from the electronic documents, wherein each field from the electronic documents is retrieved using the retrieval module;
comparing the summed value with the pre-summed balance;
validating if the summed value and pre-summed balance are tallied;
storing the entire batch of the electronic documents to the transaction eLedger and the master eLedger using the transaction processing module, if the summed value and pre-summed balance is tallied; and
prompting an output error, if the summed value and pre-summed balance is not tallied.

46. The method according to claim 37, further comprising the steps of:
providing a storage processing module;
obtaining at least one index and at least one data relative page of an electronic file having a document identifier, date, end sequence number, document status, document offset and document length from an index module based on the identifier;
retrieving the electronic document from a paging module based on the index and the data relative page in the relational database management system;
storing the electronic document in a virtual memory; and
updating the index module.

47. The method according to claim 37, further comprising the steps of:
providing an enquiry processing module;
retrieving a plurality of electronic document information based on at least one Information for the electronic document identifier, section, rowtype or column of the electronic document using the enquiry processing module; and
displaying the retrieved electronic document information having at least one file history into at least one list form.

48. The method according to claim 37, further comprising the steps of:
providing a parallel processing module;
receiving instructions to create a plurality of databases and a ledger identifier to be processed from a program;
creating databases based on the input instruction;
distributing the electronic documents from the defined ledger to the databases created based on the last 2 or 3 digits of an account number is used to determine which database the electronic document is to be distributed using the paging and index modules;
initiating parallel processing once all electronic documents have been distributed into the designated databases; and
updating the processed result to a predefined control eLedger through the mapping module.

49. The method according to claim 37, further comprising the steps of:
providing a mapping processing module;
receiving a source electronic document from a program;
parsing the source electronic document for later operation using an extraction module;
identifying and loading the destination electronic document from the source electronic document using the read module;
loading a predetermined mapping instructions;
validating if there are more mapping instruction;
validating if the data of the predetermined source column fulfils predetermined requirements from the mapping instruction, if there are more mapping instruction;
performing computation on the data of the predetermined source column from the mapping instruction, if the data of the predetermined source column fulfills the predetermined requirements from the mapping instruction, then; and
storing the updated destination of the electronic document back into the database using the paging and index modules.

50. The method according to claim 37, further comprising the steps of:
providing a mapping processing module;
receiving the electronic document from a program;
storing the received electronic document into a transaction eFile using paging and indexing modules;
updating the received electronic document to the transaction eLedger using the paging and indexing modules;
verifying if the transaction eLedger was updated successfully;
storing the received electronic document into a master eFile using the paging and indexing modules, if the received electronic document was updated successfully;
updating the received electronic document to the master eLedger using the mapping processing module;
verifying if the master eLedger was updated successfully; and
returning the update status, if the master eLedger was updated successfully.
